(19) United States
(12) Patent Application Publication
(10) Pub. No.: US 2025/0335914 A1
(43) Pub. Date: Oct. 30, 2025

(54) TRANSACTION CHAINING

(71) Applicant: Tencent Technology (Shenzhen) Company Limited, Shenzhen (CN)

(72) Inventor: Gengliang ZHU, Shenzhen (CN)

(73) Assignee: Tencent Technology (Shenzhen) Company Limited, Shenzhen, GD (CN)

(21) Appl. No.: 19/262,076

(22) Filed: Jul. 7, 2025

Related U.S. Application Data
(63) Continuation of application No. PCT/CN2023/131211, filed on Nov. 13, 2023.

(30) Foreign Application Priority Data
May 18, 2023 (CN) 202310566205.5

(51) Int. Cl. G06Q 20/40; G06Q 20/38

(52) U.S. Cl. CPC G06Q 20/401; G06Q 20/3821

(57) ABSTRACT

A to-be-processed local transaction and first verification information corresponding to the to-be-processed local transaction are received. The to-be-processed local transaction is located in a to-be-processed local block recorded on a local blockchain. Block headers corresponding to a plurality of local blocks recorded on the local blockchain are received. The plurality of local blocks includes the to-be-processed local block. First verification of the block headers corresponding to the plurality of local blocks is performed. Second verification is performed based on the to-be-processed local transaction, the first verification information, and a block header of the to-be-processed local block to authenticate the local transaction. A to-be-processed global transaction is generated based on the to-be-processed local transaction and the first verification and the second verification succeeding. The to-be-processed global transaction is recorded into a global blockchain.

### RELATED APPLICATIONS

The present application is a continuation of International Application No. PCT/CN2023/131211, filed on Nov. 13, 2023, which claims priority to Chinese Patent Application No. 202310566205.5, filed on May 18, 2023. The entire disclosures of the prior applications are hereby incorporated by reference.

### FIELD OF THE TECHNOLOGY

This disclosure relates to the field of blockchains, including to a transaction chaining method, a related apparatus, and a medium.

### BACKGROUND OF THE DISCLOSURE

A hierarchical blockchain consensus network includes a local consensus network and a global consensus network. A local transaction that is in the local consensus network and that is used to generate a global transaction is forwarded to the global consensus network through a third-party relay, so that the global consensus network generates the global transaction.

However, in a process of transmitting the local transaction to the global consensus network, once the third-party relay cheats or network attack occurs in the transmission process, it is difficult to ensure security of forwarding the transaction across chains, and accuracy of chaining the global transaction is low.

### SUMMARY

Aspects of this disclosure provide a transaction chaining method, a related apparatus, and a medium, which can improve security of forwarding a transaction across chains in a hierarchical blockchain consensus system and improve accuracy of chaining a global transaction.

According to an aspect of this disclosure, a transaction chaining method is provided. In a transaction chaining method, performed by a global consensus node within a hierarchical blockchain network, a to-be-processed local transaction and first verification information corresponding to the to-be-processed local transaction are received. The to-be-processed local transaction is located in a to-be-processed local block recorded on a local blockchain. Block headers corresponding to a plurality of local blocks recorded on the local blockchain are received. The plurality of local blocks includes the to-be-processed local block. First verification of the block headers corresponding to the plurality of local blocks is performed. Second verification is performed based on the to-be-processed local transaction, the first verification information, and a block header of the to-be-processed local block to authenticate the local transaction. A to-be-processed global transaction is generated based on the to-be-processed local transaction, and the first verification and the second verification succeeding. The to-be-processed global transaction is recorded into a global blockchain.

According to an aspect of the disclosure, a transaction chaining system of a hierarchical blockchain network is disclosed. The system includes a global consensus node including processing circuitry. The processing circuitry is configured to receive a to-be-processed local transaction and first verification information corresponding to the to-be-processed local transaction. The to-be-processed local transaction is located in a to-be-processed local block recorded on a local blockchain. The processing circuitry is configured to receive block headers corresponding to a plurality of local blocks recorded on the local blockchain, the plurality of local blocks including the to-be-processed local block. The processing circuitry is configured to perform first verification of the block headers corresponding to the plurality of local blocks to confirm an integrity of the block headers. The processing circuitry is configured to perform second verification based on the to-be-processed local transaction, the first verification information, and a block header of the to-be-processed local block to authenticate the local transaction. The processing circuitry is configured to generate a to-be-processed global transaction based on the to-be-processed local transaction, and the first verification and the second verification succeeding. The processing circuitry is configured to record the to-be-processed global transaction into a global blockchain.

According to an aspect of the disclosure, a non-transitory computer-readable storage medium is disclosed. The non-transitory computer-readable storage medium stores instructions which when executed by a processor of a global consensus node cause the at least one processor to receive a to-be-processed local transaction and first verification information corresponding to the to-be-processed local transaction. The to-be-processed local transaction is located in a to-be-processed local block recorded on a local blockchain. The instructions cause the at least one processor to receive block headers corresponding to a plurality of local blocks recorded on the local blockchain, the plurality of local blocks including the to-be-processed local block. The instructions cause the at least one processor to perform first verification of the block headers corresponding to the plurality of local blocks. The instructions cause the at least one processor to perform second verification based on the to-be-processed local transaction, the first verification information, and a block header of the to-be-processed local block to authenticate the local transaction. The instructions cause the at least one processor to generate a to-be-processed global transaction based on the to-be-processed local transaction, and the first verification and the second verification succeeding. The at least one processor records the to-be-processed global transaction into a global blockchain.

According to an aspect of this disclosure, a transaction chaining apparatus is provided. The apparatus is deployed in a global consensus node and includes: a first receiving unit, configured to receive a to-be-processed local transaction and first verification information corresponding to the to-be-processed local transaction, the to-be-processed local transaction being located in a to-be-processed local block, and the to-be-processed local block being recorded on a local blockchain; a second receiving unit, configured to receive block headers respectively corresponding to a plurality of local blocks recorded on the local blockchain, the plurality of local blocks including the to-be-processed local block; a first verification unit, configured to perform first verification based on the block headers respectively corresponding to the plurality of local blocks; a second verification unit, configured to perform second verification based on the to-be-processed local transaction, the first verification information, and a block header of the to-be-processed local block; and a permitting unit, configured to: generate a to-be-processed global transaction based on the to-be-processed local transaction after both the first verification and the second verification succeed, and record the to-be-processed global transaction into a global blockchain.

According to an aspect of this disclosure, an electronic device is provided, including a memory and a processor, the memory having a computer program stored therein, and the processor, when executing the computer program, implementing the transaction chaining method described above.

According to an aspect of this disclosure, a non-transitory computer-readable storage medium is provided, the storage medium storing instructions which when executed by a processor, cause the processor to implement the transaction chaining method described above.

According to an aspect of this disclosure, a computer program product is provided, including a computer program, the computer program being read and executed by a processor of a computer device, to cause the computer device to perform the transaction chaining method described above.

In aspects of this disclosure, in addition to receiving the to-be-processed local transaction for generating the to-be-processed global transaction, the global consensus node in the global consensus network further receives the first verification information corresponding to the to-be-processed local transaction, and the block headers of the local blocks recorded on the local blockchain. The global consensus node performs, based on the block headers of the local blocks, security verification, that is, the first verification, on the to-be-processed local block in which the to-be-processed local transaction is located. The global consensus node performs security verification, that is, the second verification, on the to-be-processed local transaction according to the to-be-processed local transaction, the first verification information, and the block header of the to-be-processed local block. The global consensus node generates the to-be-processed global transaction based on the to-be-processed local transaction after both the verification succeeds, and records the to-be-processed global transaction into the global blockchain. Through two times of security verification, insecurity caused by cheating of a third-party relay or network transmission is greatly reduced, and security of forwarding the transaction across chains and accuracy of chaining the global transaction are improved.

### BRIEF DESCRIPTION OF THE DRAWINGS

The accompanying drawings are used to provide a further understanding of technical solutions of this disclosure, and constitute a part of the specification, are used to explain the technical solutions in this disclosure in combination with the aspects of this disclosure, and do not constitute a limitation on the technical solutions in this disclosure.

FIG. 1 is a schematic architectural diagram of a hierarchical blockchain consensus network applicable to an aspect of the disclosure;

FIG. 2 is a schematic diagram of applying a transaction chaining method to an electronic invoice summarizing scenario according to an aspect of this disclosure;

FIG. 3 is a flowchart of a transaction chaining method according to an aspect of this disclosure;

FIG. 4 is a schematic diagram of an implementation process of the transaction chaining method in FIG. 3;

FIG. 5 is a flowchart of receiving a to-be-processed local transaction by using a first relay node in operation 310 in FIG. 3;

FIG. 6 is a schematic diagram in which a new local block is added to a local blockchain in FIG. 4;

FIG. 7 is a flowchart of adding a first mark in a local consensus node before operation 511 in FIG. 5;

FIG. 8 is a flowchart of receiving first verification information by using a first relay node in operation 310 in FIG. 3;

FIG. 9A is a schematic diagram of an implementation process of generating a first tree according to an aspect of this disclosure;

FIG. 9B is a schematic diagram of a first bypass feature of a first path of a first tree according to an aspect of this disclosure;

FIG. 10 is a flowchart of performing queued sending by a first relay node in a queue according to an aspect of this disclosure;

FIG. 11 is a schematic diagram of an implementation process of performing queued sending in queues of different transaction types according to an aspect of this disclosure;

FIG. 12 is a flowchart of a specific implementation of operation 1013 in FIG. 10;

FIG. 13 is a flowchart of performing queued sending by a first relay node according to transaction priorities and timestamps according to an aspect of this disclosure;

FIG. 14 is a schematic diagram of a specific implementation of queued sending in FIG. 13;

FIG. 15 is a flowchart of a specific implementation of operation 1312 in FIG. 13;

FIG. 16 is a flowchart of performing authentication on a first relay node based on a blockchain management contract in FIG. 3;

FIG. 17 is a flowchart of receiving a block header by using a second relay node in operation 320 in FIG. 3;

FIG. 18 is a flowchart of performing authentication on a second relay node based on a blockchain management contract in FIG. 3;

FIG. 19 is a schematic diagram of an implementation process of performing first verification based on block headers of local blocks;

FIG. 20 is a flowchart of a specific implementation of operation 340 in FIG. 3;

FIG. 21 is a flowchart of a specific implementation of operation 350 in FIG. 3;

FIG. 22 is a flowchart of distinguishing different global blockchains based on a blockchain management contract in FIG. 3;

FIG. 23 is a flowchart of implementing second verification based on a first verification contract and based on a second verification contract in FIG. 3;

FIG. 24 is a diagram of interaction among a plurality of sides according to a detailed aspect of this disclosure;

FIG. 25 is a diagram of modules of a transaction chaining apparatus according to an aspect of this disclosure;

FIG. 26 is a structural diagram of a terminal of the transaction chaining method in FIG. 3 according to an aspect of this disclosure; and

FIG. 27 is a structural diagram of a server of the transaction chaining method in FIG. 3 according to an aspect of this disclosure.

### DESCRIPTION OF ASPECTS

To make the objectives, technical solutions, and advantages of this disclosure clearer, the following further describes this disclosure in further detail with reference to the accompanying drawings and the aspects. The specific aspects described herein are merely used to explain this disclosure and are not intended to limit this disclosure.

Before the aspects of this disclosure are described in further detail, description is made examples of terms in the aspects of this application, and the terms in the aspects of this disclosure are applicable to the following explanations. The descriptions of the terms are provided as examples only and are not intended to limit the scope of the disclosure.

Artificial intelligence: Artificial intelligence involves a theory, a method, a technology, and an application system that use a digital computer or a machine controlled by the digital computer to simulate, extend, and expand human intelligence, perceive an environment, obtain knowledge, and use knowledge to obtain a target result. In other words, artificial intelligence is a comprehensive technology in computer science and attempts to understand the essence of intelligence and produce a new intelligent machine that can react in a manner similar to human intelligence. Artificial intelligence may be used to study the design principles and implementation methods of various intelligent machines, to enable the machines to have the functions of perception, reasoning, and decision-making. The artificial intelligence technology is a comprehensive discipline, and relates to a wide range of fields including both hardware-level technologies and software-level technologies. The basic artificial intelligence technologies may include technologies such as a sensor, a dedicated artificial intelligence chip, cloud computing, distributed storage, a big data processing technology, an operating/interaction system, and electromechanical integration. Artificial intelligence software technologies may mainly include several major directions such as a computer vision technology, a speech processing technology, a natural language processing technology, and machine learning/deep learning. With the research and progress of the artificial intelligence technology, the artificial intelligence technology has been researched and applied in a plurality of fields, such as common smart homes, smart wearable devices, virtual assistants, smart speakers, smart marketing, autonomous driving, drones, robots, smart healthcare, and smart customer service. It is believed that with the development of the technology, the artificial intelligence technology may be applied in more fields, and play an increasingly important role.

Blockchain: A blockchain is a new application mode of computer technologies such as distributed data storage, point-to-point transmission (a P2P network), a consensus mechanism, and an encryption algorithm. The blockchain is a decentralized database, and is a string of data blocks generated through association by using a cryptographic method. Each data block includes information about a batch of transactions, and the information may be configured for verifying validity (anti-counterfeiting) of the information and associating with a previous block.

P2P network: A P2P network is a point-to-point network. The P2P network is based on a special type of network protocol. Network statuses of network nodes do not need to be maintained by a central node, and instead, each node may interact with a neighboring node in broadcast mode to maintain a node status of the entire network or a connection status of the neighboring node.

Smart contract: The smart contract is a segment of code written on a blockchain. Once a clause in the contract is triggered on the blockchain at a specific time, the code may be automatically executed.

The hierarchical blockchain consensus system includes a local consensus network and a global consensus network. A local transaction that is in the local consensus network and that is used to generate a global transaction is forwarded to the global consensus network through a third-party relay, so that the global consensus network generates the global transaction.

Currently, the related art has no technology for ensuring security in a process of transmitting the local transaction to the global consensus network. Once a third-party relay cheats or network attack occurs in a transmission process, it is difficult to ensure security of forwarding the transaction across chains, and accuracy of chaining the global transaction is low.

Description of an Architecture and a Scenario of a System to which the Aspects of this Disclosure are Applied

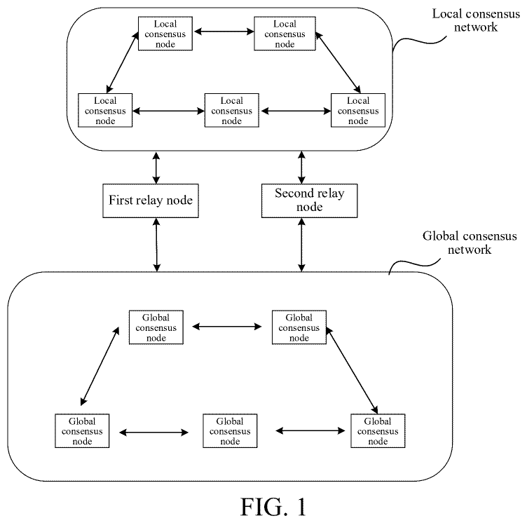

Referring to a hierarchical blockchain consensus network shown in FIG. 1, the hierarchical blockchain consensus network is a blockchain network for performing hierarchical consensus on a transaction. The hierarchical blockchain consensus network includes a local consensus network, a global consensus network, a first relay node, and a second relay node. The local consensus network is a network that performs consensus on and chains a local transaction, and includes a plurality of local consensus nodes. The local transaction is a transaction that has impact only within a local scope. For example, an electronic invoice reimbursement transaction of a subsidiary of a corporation is a local transaction. The global consensus network is a network that performs consensus on and chains a global transaction derived from local transactions, and includes a plurality of global consensus nodes. The global transaction is a transaction that has impact within a global scope. For example, a transaction in which a corporation summarizes electronic invoice reimbursement of a subsidiary is a global transaction. The first relay node and the second relay node are both interface nodes between the local consensus node and the global consensus node, and forward, to the global consensus network, local transactions generated by the local consensus network, so that the global consensus network summarizes the local transactions into a global transaction and chains the global transaction.

The local consensus node and the global consensus node are both consensus nodes, and are also referred to as blockchain nodes. Consensus nodes or blockchain nodes can be electronic devices in the blockchain network such as servers in the blockchain network, or electronic devices connected to the blockchain network such as user terminals connected to the blockchain network. Specific forms of consensus nodes or blockchain nodes are not limited herein. The first relay node and the second relay node are both interface nodes. The first relay node and the second relay node may be independent devices such as independent computers or servers, or may be parts of independent devices such as virtual machines obtained by dividing servers. Specific forms of the first relay node and the second relay node are not limited herein.

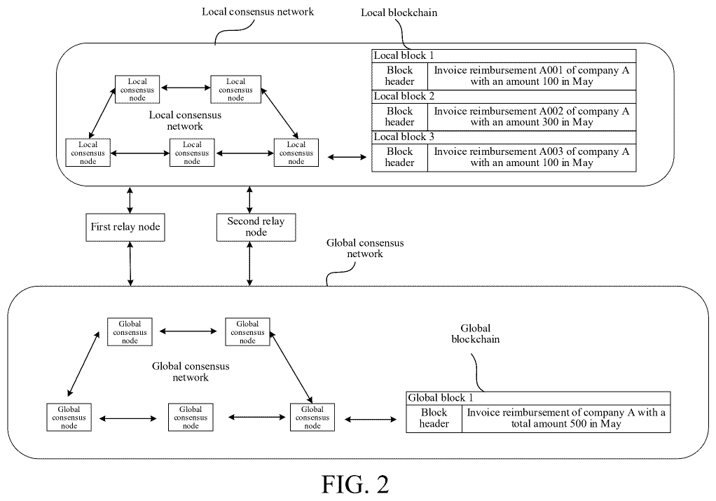

Aspects of this disclosure may be applied to a plurality of scenarios such as an electronic invoice summarizing scenario shown in FIG. 2.

FIG. 2 is different from FIG. 1 in that FIG. 2 further shows a local blockchain maintained by a local consensus network and a global blockchain maintained by a global consensus network. The local blockchain and the global blockchain are both the blockchains described above. A specific process of recording the local transaction into the local blockchain is as follows:

A terminal of an object (for example, a terminal of a user) may generate a local transaction based on an operation behavior of the object (for example, the user), and send the local transaction and a digital signature of the terminal of the object to a nearby local consensus node on a local consensus network, so that the local consensus node performs verification on authenticity of the local transaction. During verification, the local consensus node performs verification on the digital signature by using a public key of the terminal of the object, to obtain a first digest value of the local transaction, performs digest calculation on the local transaction according to a digest algorithm, to obtain a second digest value of the local transaction, and compares the first digest value with the second digest value. If the first digest value is the same as the second digest value, the verification succeeds, and the local transaction is a true transaction generated by the terminal of the object.

After the verification succeeds, the local transaction and another local transaction sent by the terminal of the object are accumulated. When accumulation reaches a degree (for example, a quantity of accumulated transactions reaches a threshold or an accumulation time reaches a threshold), these local transactions are packaged into a local block, and the local block is sent to another first consensus node in the local consensus network to perform consensus. After the consensus succeeds, each local consensus node records the local block into a local blockchain maintained by the local consensus node.

Still referring to FIG. 2, the local blockchain includes three local blocks. Local blocks 1 to 3 record three local transactions, and the local transactions are respectively “invoice reimbursement A001 of company A with an amount 100 in May”, “invoice reimbursement A002 of company A with an amount 300 in May”, and “invoice reimbursement A003 of company A with an amount 100 in May”. The three local transactions on the local blockchain are forwarded to the global consensus node in the global consensus network by using the first relay node or the second relay node. The global consensus node generates a global transaction based on the three local transactions, for example, “invoice reimbursement of company A with a total amount 500 in May”, and then generates a global block for the global transaction and records the global block into the global blockchain. A specific process of recording the global transaction into the global blockchain is similar to the foregoing specific process of recording the local transaction into the local blockchain, and details are not described herein again.

As can be seen, once a third-party relay cheats (for example, the first relay node or the second relay node cheats) or network attack occurs in the transmission process (for example, a process in which the local transaction on the local blockchain is transmitted to the global blockchain), it is difficult to ensure security of forwarding the transaction across chains, and accuracy of chaining the global transaction is low.

Description of the Aspects of this Disclosure

According to an aspect of this disclosure, a transaction chaining method is provided.

The transaction chaining method is applied to a service scenario in which a transaction forwarding security requirement is high, for example, the electronic invoice summarizing scenario shown in FIG. 2. A transaction recorded on the local blockchain is referred to as a local transaction, and a local transaction for summarizing is referred to as a to-be-processed local transaction. A transaction obtained by summarizing a plurality of to-be-processed local transactions is referred to as a global transaction. This aspect of this disclosure provides a solution in which dual security verification is performed before a global transaction is chained, and can improve security of chaining the global transaction. The transaction chaining method is executed by a global consensus node in a hierarchical blockchain consensus network.

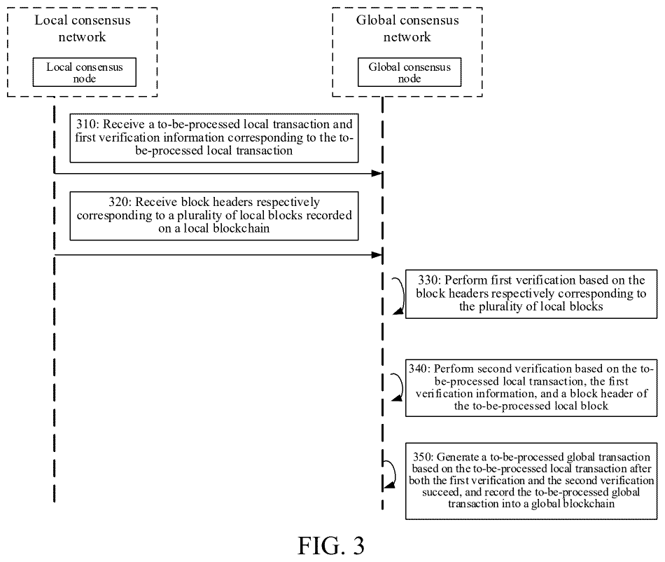

As shown in FIG. 3, a transaction chaining method according to an aspect of this disclosure may include:

Operation 310: Receive a to-be-processed local transaction and first verification information corresponding to the to-be-processed local transaction, the to-be-processed local transaction being located in a to-be-processed local block, and the to-be-processed local block being recorded on a local blockchain.

Operation 320: Receive block headers respectively corresponding to a plurality of local blocks recorded on the local blockchain, the plurality of local blocks including the to-be-processed local block.

Operation 330: Perform first verification based on the block headers respectively corresponding to the plurality of local blocks. In an example, first verification of the block headers respectively corresponding to the plurality of local blocks is performed.

Operation 340: Perform second verification based on the to-be-processed local transaction, the first verification information, and a block header of the to-be-processed local block. In an example, second verification is performed based on the to-be-processed local transaction, the first verification information, and a block header of the to-be-processed local block to authenticate the local transaction.

Operation 350: Generate a to-be-processed global transaction based on the to-be-processed local transaction after both the first verification and the second verification succeed, and record the to-be-processed global transaction into a global blockchain. In an example, a to-be-processed global transaction is generated based on the to-be-processed local transaction and the first verification and the second verification succeeding.

The following describes examples of operations 310 to 350 in further detail.

In operation 310, the local transaction is a transaction recorded on the local blockchain, and the to-be-processed local transaction is a local transaction for summarizing. The local blockchain includes the plurality of local blocks. A local transaction is located in a local block, and a local block in which a to-be-processed local transaction is located is referred to as a to-be-processed local block. The first verification information is information configured for verifying that a local consensus node truly chains a local transaction.

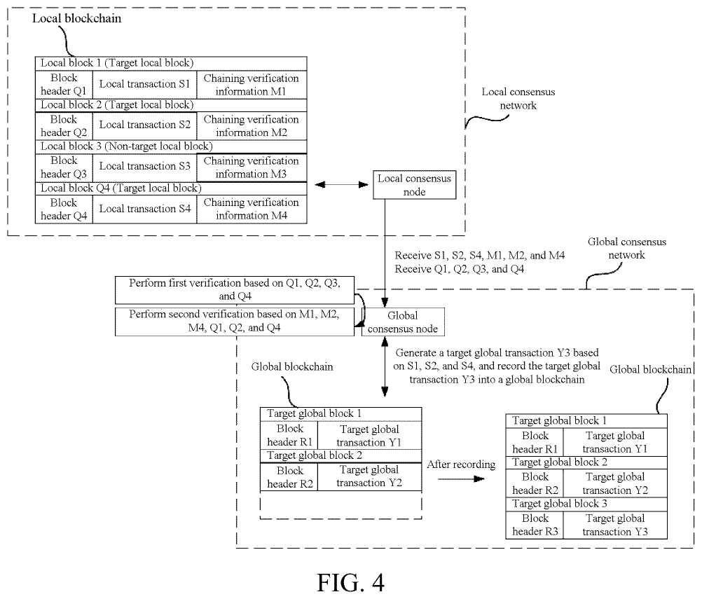

For example, referring to FIG. 4, a local blockchain stores four local blocks, including a local block 1, a local block 2, a local block 3, and a local block 4. Local transactions on the local blocks include a local transaction S1 (the local transaction S1 is, for example, “invoice reimbursement A001 of company A with an amount 100 in May”), a local transaction S2 (the local transaction S2 is, for example, “invoice reimbursement A002 of company A with an amount 300 in May”), a local transaction S3 (the local transaction S3 is, for example, “office supply order A1001 of company A with an amount 1000 in May”), and a local transaction S4 (the local transaction S4 is, for example, “invoice reimbursement A003 of company A with an amount 100 in May”). Each local block may be a to-be-processed local block or a non-to-be-processed local block. If a local block stores a local transaction for summarizing, the local block is a to-be-processed local block. Local transactions for summarizing include the local transaction S1, the local transaction S2, and the local transaction S4. Therefore, the local block 1, the local block 2, and the local block 4 are to-be-processed local blocks, and the local block 3 is a non-to-be-processed local block. Each local block includes a block header and a block body, and the block body specifically includes a local transaction and first verification information. The local block 1 includes a block header Q1, the local transaction S1, and first verification information M1. The local block 2 includes a block header Q2, the local transaction S2, and first verification information M2. The local block 3 includes a block header Q3, the local transaction S3, and first verification information M3. The local block 4 includes a block header Q4, the local transaction S4, and first verification information M4.

In some aspects, setting of a receiving cycle of the to-be-processed local transaction and the first verification information includes, but is not limited to, the following cases:

(1) A to-be-processed local transaction and first verification information are received after it is found that a new to-be-processed local block is added to the local blockchain maintained by the local consensus node.

(2) According to a first receiving cycle preset by the global consensus node, a to-be-processed local transaction and first verification information are received when it is found that a new to-be-processed local block is added to the local blockchain maintained by the local consensus node and the first receiving cycle is passed.

In some aspects, a manner of receiving the to-be-processed local transaction and the first verification information includes, but is not limited to, the following manners:

(1) The global consensus node passively receives a to-be-processed local transaction and first verification information. This specifically includes: After a new to-be-processed local block is added to the local blockchain maintained by the local consensus node, the local consensus node automatically sends a local transaction and first verification information to the global consensus node.

(2) The global consensus node actively receives a to-be-processed local transaction and first verification information. This specifically includes: The global consensus node sends a summarizing command to the local consensus node. After adding a new to-be-processed local block to the local blockchain in response to the summarizing command, the local consensus node sends a to-be-processed local transaction and first verification information in the to-be-processed local block to the global consensus node.

For example, still referring to FIG. 4, to-be-processed local blocks on the local blockchain include the local block 1, the local block 2, and the local block 4. Therefore, to-be-processed local transactions received by the global consensus network include the local transaction S1, the local transaction S2, and the local transaction S4. Correspondingly, first verification information received by the global consensus network includes the first verification information M1, the first verification information M2, and the first verification information M4.

In operation 320, similar to the local transaction and the first verification information, the block header is also stored in the local block. In operation 310, the to-be-processed local transaction and the first verification information corresponding to the to-be-processed local transaction are received, but in operation 320, a block header corresponding to a non-to-be-processed local transaction is also received in addition to the block header corresponding to the to-be-processed local transaction.

In some aspects, setting of a receiving cycle of the block header includes, but is not limited to, the following cases:

(1) The block header is immediately received after it is found that the local consensus node sends the to-be-processed local transaction and the first verification information to the global consensus network.

(2) According to a second receiving cycle preset by the global consensus node, the block header is received when it is found that the local consensus node sends the to-be-processed local transaction and the first verification information to the global consensus network and the second receiving cycle is passed.

In some aspects, a manner of receiving the block header includes, but is not limited to, the following manners:

(1) The global consensus node passively receives a block header. This specifically includes: After the local consensus node automatically sends the local transaction and the first verification information to the global consensus node, the local consensus node then automatically sends the block header to the global consensus node.

(2) The global consensus node actively receives a block header. This specifically includes: The global consensus node sends a summarizing command to the local consensus node. The local consensus node sends a to-be-processed local transaction, first verification information, and a block header in a to-be-processed local block to the global consensus node in response to the summarizing command.

For example, still referring to FIG. 4, the to-be-processed local blocks on the local blockchain include the local block 1, the local block 2, the local block 3, and the local block 4. Therefore, the block header received by the global consensus network includes the block header Q1, the block header Q2, the block header Q3, and the block header Q4.

In operation 330, the first verification is performed based on the block headers respectively corresponding to the plurality of local blocks. The first verification refers to performing security verification on a to-be-processed local block in which a to-be-processed local transaction is located. Among a plurality of block headers, a next block header and a previous block header are associated with each other. It may be verified, through the first verification, whether the association between the plurality of block headers is accurate and is not tampered with. The to-be-processed local block in which the to-be-processed local transaction is located is also included in the plurality of block headers, thereby implementing security verification on the to-be-processed local block in which the to-be-processed local transaction is located.

For example, still referring to FIG. 4, the first verification is performed based on the block header Q1, the block header Q2, the block header Q3, and the block header Q4. After the first verification succeeds, it indicates that the local block 1, the local block 2, and the local block 4, that is, the to-be-processed local blocks are secure.

In operation 340, the second verification is performed based on the to-be-processed local transaction, the first verification information, and the block header of the to-be-processed local block. The second verification refers to performing security verification on the to-be-processed local transaction. A specific process of the second verification is described in detail below.

For example, still referring to FIG. 4, the second verification is performed based on the first verification information M1, the first verification information M2, the first verification information M4, the block header Q1, the block header Q2, and the block header Q4. After the second verification succeeds, it indicates that the local transaction S1, the local transaction S2, and the local transaction S4, that is, the to-be-processed local transactions are secure.

In operation 350, after both the first verification and the second verification succeed, it indicates that the to-be-processed local block in which the to-be-processed local transaction is located is secure, and the to-be-processed local transaction itself is also secure. In this case, it is permitted that the to-be-processed global transaction is generated based on the to-be-processed local transaction and is recorded into the global blockchain.

For example, still referring to FIG. 4, before the current recording, the global blockchain has stored a global block 1 and a global block 2. The global block 1 stores a block header R1 and a to-be-processed global transaction Y1. The global block 2 stores a block header R2 and a to-be-processed global transaction Y2. A to-be-processed global transaction Y3 is generated based on the local transaction S1, the local transaction S2, and the local transaction S4, that is, the to-be-processed local transactions (the to-be-processed global transaction Y3 is, for example, “invoice reimbursement of company A with a total amount 500 in May”), and a global block 3 is generated based on the to-be-processed global transaction Y3. The global block 3 stores a block header R3 and the to-be-processed global transaction Y3, and the global block 3 is recorded into the global blockchain (that is, a dashed-line box on the global blockchain). After recording is completed, the global blockchain stores the global block 1, the global block 2, and the global block 3.

In operations 310 to 350, in addition to the to-be-processed local transactions for generating the to-be-processed global transaction, the global consensus network in this aspect of this disclosure further receives the first verification information corresponding to the to-be-processed local transactions, and the block headers of the local blocks recorded on the local blockchain. Security verification is performed, based on the block headers of the local blocks, on a to-be-processed local block in which a to-be-processed local transaction is located. Security verification is performed on the to-be-processed local transaction based on the to-be-processed local transaction, the first verification information, and the block header of the to-be-processed local block. After both the verification succeeds, insecurity caused by cheating of a third-party relay or network transmission is greatly reduced, and security of forwarding the transaction across chains and accuracy of chaining the global transaction are improved.

Overall description of operations 310 to 350 is provided above, and detailed description of operations 310 to 350 is provided below.

### Detailed Description of Operation 310

Operation 310: Receive a to-be-processed local transaction and first verification information corresponding to the to-be-processed local transaction. As shown in FIG. 4, the global consensus node receives a to-be-processed local transaction and first verification information from the local consensus node. However, actually, cross-chain information transmission on a blockchain network is usually performed through forwarding by a third party. In this aspect of this disclosure, a first relay node is used to implement information transmission between the local consensus network and the global consensus network.

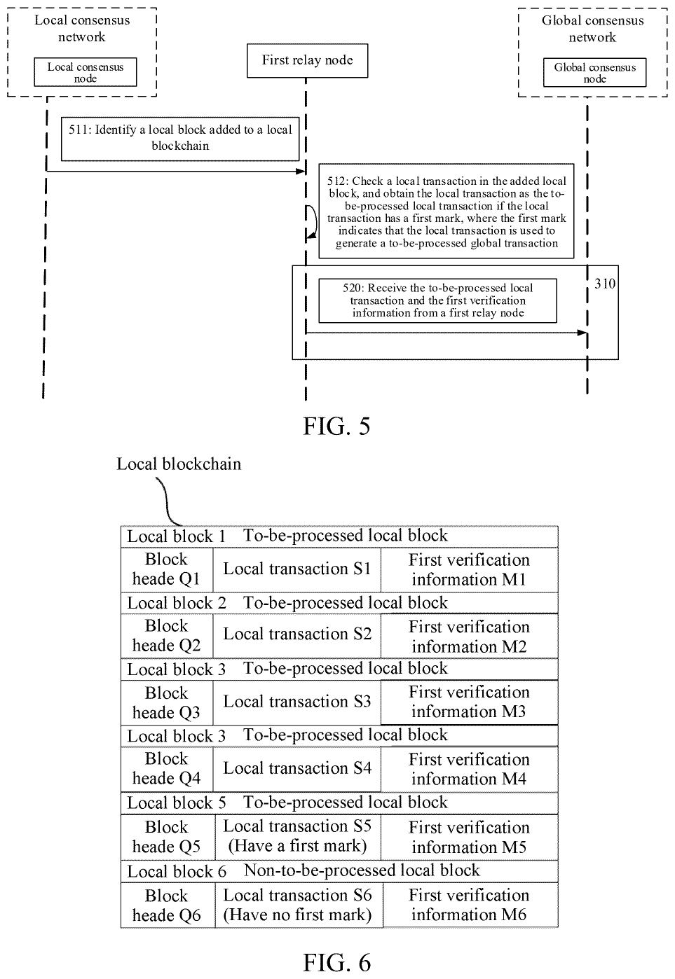

In a specific implementation of this aspect, referring to FIG. 5, operation 310 includes:

Operation 520: Receive the to-be-processed local transaction and the first verification information from the first relay node.

Then, operation 520 is divided into two cases. A first case is that the first relay node receives the to-be-processed local transaction. A second case is that the first relay node receives the first verification information.

In the first case, the to-be-processed local transaction is obtained by the first relay node in the following manner:

Operation 511: Identify a local block added to a local blockchain.

Operation 512: Check a local transaction in the added local block, and obtain the local transaction as the to-be-processed local transaction if the local transaction has a first mark, where the first mark indicates that the local transaction is used to generate the to-be-processed global transaction.

The following describes operations 511 and 512 in detail.

In operation 511, the local block added to the local blockchain can be identified. However, whether a local transaction stored in the local block is a to-be-processed local transaction or a non-to-be-processed local transaction is not known. The first relay node identifies whether a local block is added to the local blockchain. If identifying that a local block is added, the first relay node checks whether a local transaction in the local block has the first mark in operation 512. If the first mark is found, it is considered that the local transaction having the first mark has been found, and the local transaction having the first mark is extracted from the added local block.

As shown in FIG. 6, compared with the local blockchain shown in FIG. 4, a local blockchain shown in FIG. 6 additionally has a local block 5 and a local block 6. It is not explicitly indicated that the local transactions in the local blocks 1 to 4 have the first mark. However, whether there is a local transaction for generating a to-be-processed global transaction may be identified in another manner. This is not limited to the manner of identifying the first mark. In this aspect, a local transaction S5 in the local block 5 has a first mark, and it indicates that the local transaction S5 is used for generating a to-be-processed global transaction. A local transaction S6 in the local block 6 does not have the first mark, and it indicates that the local transaction S6 in the local block 6 does not need to be used for generating a to-be-processed global transaction.

For example, the local transaction S5 is “invoice reimbursement 004 of company A with an amount 200 in June, [first mark]”, and the local transaction S6 is “office supply order 1002 of company A with an amount 400 in June”. In this case, the local transaction S5 has the first mark, and the first relay node obtains the local transaction S5 from the local block 5 as a to-be-processed local transaction, and obtains the first verification information M5. The local transaction S6 does not have the first mark, and the first relay node neither needs to obtain the local transaction S6, nor needs to obtain the first verification information M6 of the local transaction S6.

This aspect has the following advantage: Many diverse local transactions are recorded on the local blockchain, and not all local transactions are used for summarizing. The first relay node may quickly select, by checking the first mark, a local transaction for summarizing and forward the local transaction to the global consensus network. This not only ensures service isolation between the local consensus network and the global consensus network, but also enables the global consensus network to be more focused on processing of the global transaction.

In some aspects, the local consensus network recording the local blockchain adds the first mark in operation 512 in the following manners:

(1) Obtain a local transaction, determine a type of the local transaction, search a type reference table according to the type of the local transaction, and add the first mark to the local transaction if determining that the type of the local transaction is a specified transaction type.

(2) Obtain a local transaction, compare the local transaction with a transaction type specified in a service contract, and add the first mark to the local transaction if determining that the local transaction belongs to the specified transaction type.

Compared with the manner (1), in the manner (2), no reference table needs to be searched, and instead fast comparison is implemented by using the service contract required in a transaction chaining process, thereby greatly improving the processing efficiency.

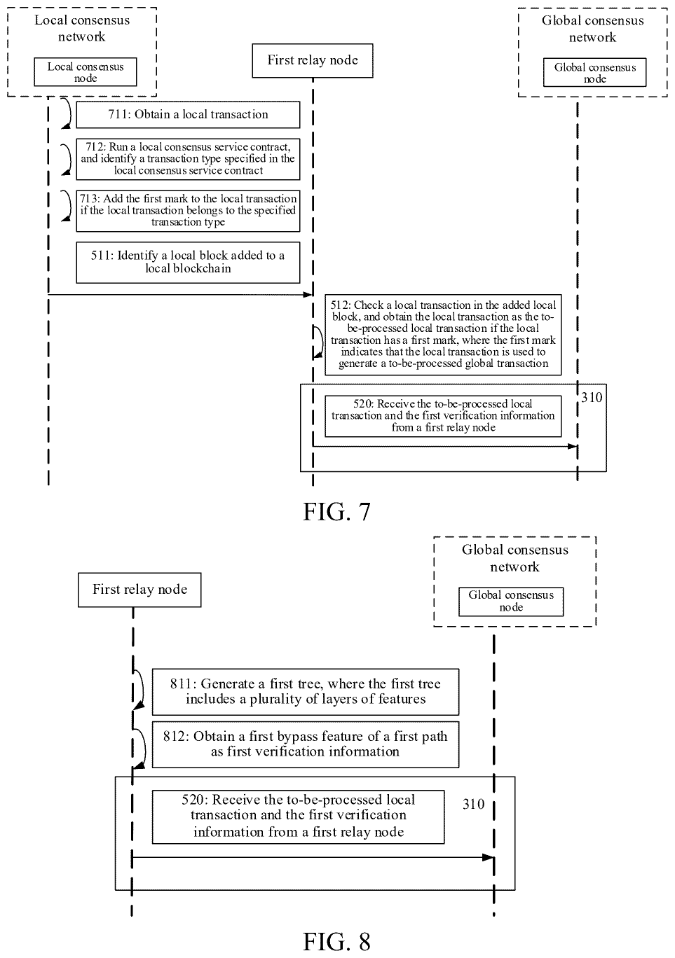

In a specific implementation of the manner (2), referring to FIG. 7, the local consensus network recording the local blockchain adds the first mark in the following manner:

Operation 711: Obtain a local transaction.

Operation 712: Run a local consensus service contract, and identify a transaction type specified in the local consensus service contract.

Operation 713: Add the first mark to the local transaction if the local transaction belongs to the specified transaction type.

The following describes operations 711 to 713 in detail.

In operation 711, the local transaction is a transaction that needs to be executed and recorded on the local blockchain, for example, a company invoice reimbursement transaction.

In some aspects, a manner of obtaining the local transaction includes, but is not limited to, the following manners:

(1) The local consensus node receives a to-be-chained transaction generated by a terminal of an object, and uses the received to-be-chained transaction as a local transaction.

(2) The local consensus node receives a to-be-chained transaction forwarded by a relay node, and uses, as a local transaction, the to-be-chained local transaction forwarded by the relay node.

In operation 712, the local consensus service contract is the smart contract described above, and the local consensus service contract is a contract that is established in advance by the local consensus network to perform various services related to the local consensus network on the local transaction. In this aspect, the transaction type specified in the local consensus service contract is mainly compared with the local transaction, to determine a transaction type of the local transaction. For example, in this aspect, the local consensus service contract is specifically an invoice reimbursement service contract, and the specified transaction type is specifically an invoice reimbursement type.

In operation 713, if the local transaction belongs to the specified transaction type, it indicates that the local transaction is a transaction for summarizing, and the first mark needs to be added.

For example, if the local transaction is “invoice reimbursement A004 of company A with an amount 200 in June”, after the invoice reimbursement service contract is run, it is identified that a transaction type specified in the invoice reimbursement service contract is an invoice reimbursement type, and the local transaction belongs to the invoice reimbursement type. In this case, after the first mark is added to the local transaction, the local transaction is “invoice reimbursement A004 of company A with an amount 200 in June, [first mark]”.

This aspect has the following advantage: A corresponding local consensus service contract usually needs to be run in a process of recording the local transaction into the local blockchain. Therefore, in this aspect, based on running of the service contract, whether the local transaction belongs to the transaction type specified in the service contract is determined, to quickly distinguish, by adding the first mark, whether the local transaction is used for summarizing. This not only improves processing efficiency, but also saves computing resources.

The first case is described above, and the second case is described below in detail.

In the second case, referring to FIG. 8, the first verification information is obtained by the first relay node in the following manner:

Operation 811: Generate a first tree, where the first tree includes a plurality of layers of features.

Operation 812: Obtain a first bypass feature of a first path as first verification information.

The following describes operations 811 and 812 in detail.

In operation 811, the features on the lowest layer of the first tree are digest values of a plurality of local transactions in the to-be-processed local block, and the plurality of local transactions include the to-be-processed local transaction. A sequence of the feature on the lowest layer of the first tree may be a sequence in which the local consensus node receives a local transaction. For example, the local consensus node first receives a local transaction 1 “invoice reimbursement B001 of company B with an amount 200 in July”, and then receives a local transaction 2 “invoice reimbursement C001 of company C with an amount 400 in July”. In this case, the local transaction 1 is used as the first node of nodes on the lowest layer, and the local transaction 2 is used as the second node of the nodes on the lowest layer. A digest algorithm used by the digest value may be one of the following:

(1) A fixed digest algorithm that is specified by the local consensus node in advance and that is the same for entities to which local transactions belong. For example, the same digest algorithm is used for an electronic invoice reimbursement transaction of company B and an electronic invoice reimbursement transaction of company C.

(2) Different digest algorithms are specified by the local consensus node in advance for entities to which local transactions belong. For example, different digest algorithms are specified in advance for company B and company C. A digest algorithm that is specified in advance for company B is used when it is determined that a local transaction belongs to company B. A digest algorithm that is specified in advance for company C is used when it is determined that a local transaction belongs to company C. In this aspect, different digest algorithms are used for different entities, increasing difficulty in cracking a local transaction from a digest value and improving local transaction chaining security.

No matter which of the foregoing digest algorithm is used, it needs to be ensured that a digest algorithm used by the global consensus node when performing verification according to the digest value of the to-be-processed local transaction and the first bypass feature is consistent with the foregoing digest algorithm.

In this aspect, two adjacent features of each layer of the first tree are connected to generate a feature on a higher layer until a first tree root feature of the first tree is generated, and the first tree root feature is a first block body digest value.

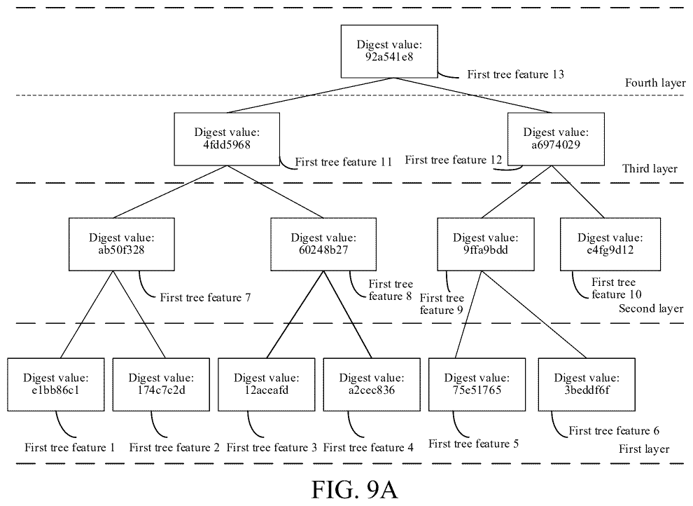

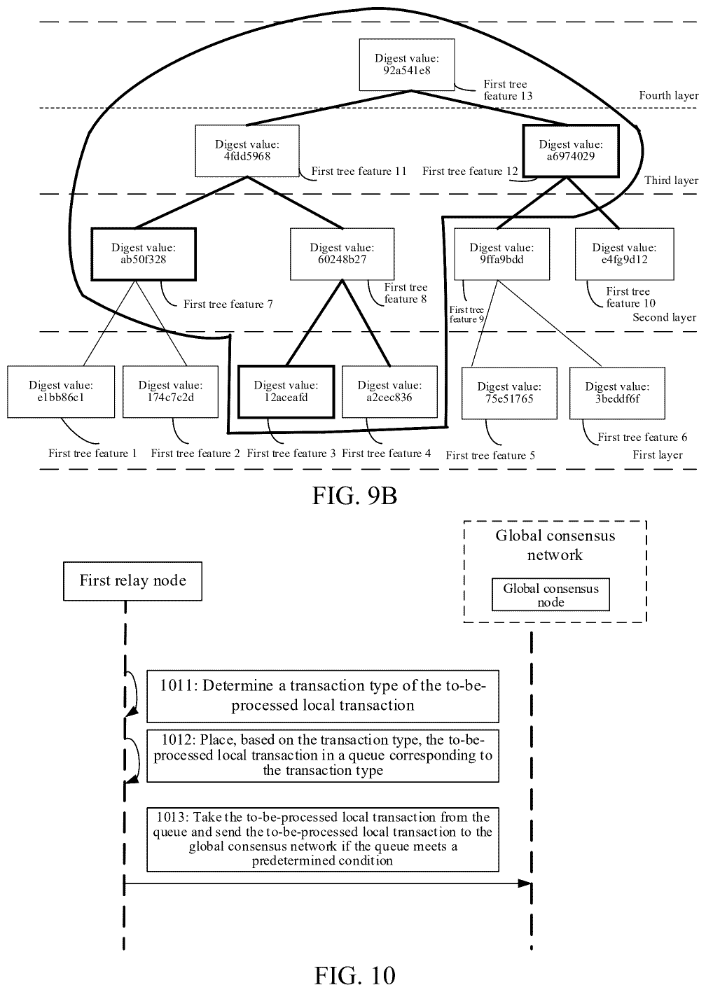

The first tree in this aspect of this disclosure is usually a binary tree or may be an n-ary tree. The first tree has all characteristics of a tree structure. The tree structure usually includes a plurality of nodes (the first tree features shown in FIG. 9A). The plurality of nodes at least include at least one leaf node and one root node, and usually further includes a plurality of intermediate nodes between the leaf node and the root node.

A specific process of generating the first tree is as follows:

Referring to the first tree shown in FIG. 9A, feature data of each first tree feature is used as a feature of the first tree. Therefore, the first tree includes a plurality of layers of features. Each feature on the lowest layer of the first tree corresponds to a single transaction recorded on a local blockchain, and each feature on the lowest layer is a feature of the recorded transaction (as shown in FIG. 9A, the feature of the transaction is a digest value). Two adjacent features on each layer of the first tree are connected to generate a feature on a higher layer, that is, each feature on a higher layer is obtained through operation by using two adjacent features on a lower layer (as shown in FIG. 9A, a digest value of a feature on a higher layer may be obtained through digest operation by using digest values of two adjacent features on a lower layer). By analogy, this repeats until a tree root feature of the first tree is generated, to obtain the complete first tree. As shown in FIG. 9A, after a first tree feature 1 and a first tree feature 2 on the lowest layer are connected in series, a first tree feature 7 on the penultimate layer is generated by using a digest algorithm. After a first tree feature 3 and a first tree feature 4 on the lowest layer are connected in series, a first tree feature 8 on the penultimate layer is generated by using a digest algorithm. After a first tree feature 5 and a first tree feature 6 on the lowest layer are connected in series, a first tree feature 9 on the penultimate layer is generated by using a digest algorithm. After a first tree feature 7 and a first tree feature 8 on the penultimate layer are connected in series, a first tree feature 11 on the antepenultimate layer is generated by using a digest algorithm. After a first tree feature 9 and a first tree feature 10 on the penultimate layer are connected in series, a first tree feature 12 on the antepenultimate layer is generated by using a digest algorithm. After the first tree feature 11 and the first tree feature 12 on the antepenultimate layer are connected in series, a first tree feature 13, that is, a first tree root feature, is generated by using a digest algorithm.

In operation 812, the first path is a path from a digest value of the to-be-processed local transaction to the first tree root feature on the first tree, and the first bypass feature is a feature on a next layer to which another feature on the first path other than the digest value of the to-be-processed local transaction is connected.

As shown in FIG. 9B, assuming that the feature of the digest value of the to-be-processed local transaction corresponds to the first tree feature 4 and the first tree root feature of the first tree corresponds to the first tree feature 13, the first path is a path from the first tree feature 4 to the first tree feature 13 on the first tree. The first path covers a connection path of the first tree feature 4, the first tree feature 8, the first tree feature 11, and the first tree feature 13. Because the first tree feature 8 needs to be generated based on the first tree feature 3 and the first tree feature 4, if a feature of the first tree feature 4 is known, a feature of the first tree feature 3 further needs to be obtained. Therefore, the feature of the first tree feature 3 is determined as a bypass feature. Similarly, because the first tree feature 11 needs to be generated based on the first tree feature 7 and the first tree feature 8, after the first tree feature 8 is generated based on the first tree feature 3 as the bypass feature and the first tree feature 4, a feature of the first tree feature 7 further needs to be obtained. Therefore, the feature of the first tree feature 7 is determined as a bypass feature. Similarly, because the first tree feature 13 needs to be generated based on the first tree feature 11 and the first tree feature 12, after the first tree feature 11 is generated based on the first tree feature 8 and the first tree feature 7 as the bypass feature, a feature of the first tree feature 12 further needs to be obtained. Therefore, the feature of the first tree feature 12 is determined as a bypass feature. Therefore, the first bypass feature of the first path includes features of the first tree feature 3, the first tree feature 7, and the first tree feature 12. The first bypass feature is represented by a black thick solid-line box in FIG. 9B. Features other than the first bypass feature and the feature on the lowest layer corresponding to the to-be-processed local transaction on the first tree are not provided to the global consensus node.

This aspect has the following advantage: When the global consensus node performs the second verification, information related to generating the first tree root feature layer by layer upwards from the first tree feature on the lowest layer corresponding to the digest value of the to-be-processed local transaction has been provided to the global consensus node, to ensure that the global consensus node can correctly perform the second verification. In addition, information unrelated to generating the first tree root feature layer by layer upwards from the first tree feature on the lowest layer corresponding to the digest value of the to-be-processed local transaction is not provided to the global consensus node as much as possible, to reduce information leakage of another transaction. In addition, even the first bypass feature is provided in a form of digest value, thereby reducing real information leakage of a related transaction.

The second case is described above in detail.

For implementation of operation 310, two implementations are provided below. Detailed description of operation 310 is provided from different perspectives in each implementation. First, a first implementation is described.

In the process of forwarding the to-be-processed local transaction and the first verification information by the first relay node, in both forwarding immediately and forwarding after a preset forwarding cycle, a connection is established with the global consensus network each time there is a to-be-processed local transaction, resulting in excessively high overheads. To reduce overheads and network resource losses, in an aspect, queuing may be first performed, and when a predetermined condition is met, packaging and sending may be performed.

In a specific implementation of this aspect, the global consensus node is located in a global consensus network. Referring to FIG. 10, the to-be-processed local transaction in operation 310 is sent to the global consensus network by the first relay node in the following manner:

Operation 1011: Determine a transaction type of the to-be-processed local transaction.

Operation 1012: Place, based on the transaction type, the to-be-processed local transaction in a queue corresponding to the transaction type.

Operation 1013: Take the to-be-processed local transaction from the queue and send the to-be-processed local transaction to the global consensus network if the queue meets a predetermined condition.

The following describes operations 1011 to 1013 in detail.

In operation 1011, the first relay node determines the transaction type of the to-be-processed local transaction. For example, the to-be-processed local transaction is an invoice reimbursement transaction, and a transaction type of the invoice reimbursement transaction is an invoice reimbursement type. For another example, the to-be-processed local transaction is a company order transaction, and a transaction type of the company order transaction is an order type.

In some aspects, a manner of determining the transaction type of the to-be-processed local transaction includes, but is not limited to, the following manners:

(1) Extract a first key field from content of the to-be-processed local transaction, and search a reference table of a first key field and a transaction type according to the first key field, to determine a transaction type of the to-be-processed local transaction. The following is an example of a reference table of the first key field and the transaction type:

TABLE 1

| First key field | Transaction type |
|---|---|
| Reimbursement | Invoice reimbursement type |
| Invoice query | Invoice query type |
| Invoice issuance | Invoice issuance type |

As shown in Table 1, when first key fields included in to-be-processed local transactions are respectively reimbursement, invoice query, and invoice issuance, it is determined that transaction types of the to-be-processed local transactions are respectively the invoice reimbursement type, the invoice query type, and the invoice issuance type.

For example, content of a to-be-processed local transaction includes “invoice reimbursement A004 of company A with an amount 200 in June”, and a first key field included in the to-be-processed local transaction is “reimbursement”. In this case, it is determined that the transaction type is the invoice reimbursement type.

(2) Obtain a type identifier from the content of the to-be-processed local transaction, and determine a transaction type of the to-be-processed local transaction according to the type identifier.

For example, content of the to-be-chained local transaction includes “invoice reimbursement A004 of company A with an amount 200 in June; [invoice reimbursement type]”. In this case, it is determined that the transaction type is the invoice reimbursement type according to the type identifier “[invoice reimbursement type]”.

In operation 1012, placing to-be-processed local transactions of the same transaction type in the same queue and sending the queue to the global consensus network help improve chaining efficiency of the global consensus network. Therefore, a plurality of queues are set and the plurality of queues include queues corresponding to transaction types, so that to-be-processed local transactions of the same transaction type are placed in the same queue.

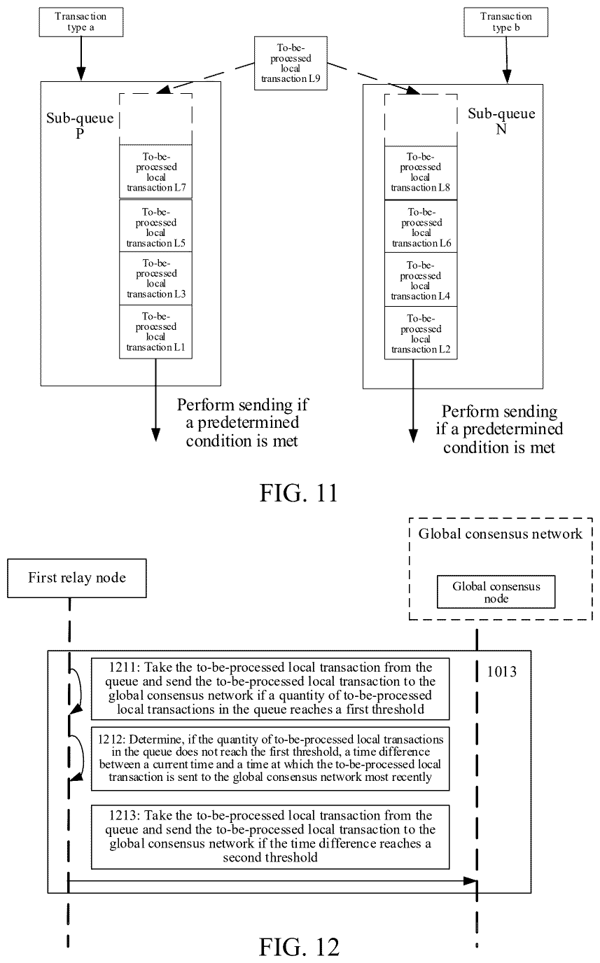

For example, FIG. 11 shows two queues. The queues are respectively a sub-queue P and a sub-queue N. The sub-queue P is used for storing a to-be-processed local transaction of a transaction type a. The sub-queue N is used for storing a to-be-processed local transaction of a transaction type b. To-be-processed local transactions L1 to L8 have been respectively placed in corresponding queues according to transaction types, that is, the to-be-processed local transactions L1, L3, L5, and L7 of the transaction type a are placed in the sub-queue P, and the to-be-processed local transactions L2, L4, L6, and L8 of the transaction type b are placed in the sub-queue N. When a to-be-processed local transaction L9 needs to be placed in a queue, a transaction type of the to-be-processed local transaction L9 is first determined. If the transaction type of the to-be-processed local transaction L9 is the transaction type a, the to-be-processed local transaction L9 is placed at the tail of the sub-queue P (at a dashed-line box of the sub-queue P shown in FIG. 11). If the transaction type of the to-be-processed local transaction L9 is the transaction type b, the to-be-processed local transaction L9 is placed at the tail of the sub-queue N (at a dashed-line box of the sub-queue N shown in FIG. 5).

In operation 1013, the predetermined condition includes at least one of the following: a quantity of to-be-processed local transactions reaches a first threshold, and a time difference between a current time and a time at which the to-be-processed local transaction is transmitted to the global consensus network most recently reaches a second threshold. For example, the first relay node takes the to-be-processed local transaction from the queue and sends the to-be-processed local transaction to the global consensus node in response to that the quantity of to-be-processed local transactions in the queue reaches the first threshold. For another example, the first relay node takes the to-be-processed local transaction from the queue and sends the to-be-processed local transaction to the global consensus node in response to that the time difference between a current time and a time at which the to-be-processed local transaction is transmitted to the global consensus network most recently in the queue reaches the second threshold. For another example, the first relay node takes the to-be-processed local transaction from the queue and sends the to-be-processed local transaction to the global consensus node in response to that the quantity of to-be-processed local transactions in the queue reaches the first threshold, and in response to that the time difference between a current time and a time at which the to-be-processed local transaction is transmitted to the global consensus network most recently in the queue reaches the second threshold.

For example, still referring to FIG. 11, after the to-be-processed local transaction L9 is placed, for example, the to-be-processed local transaction L9 is placed in the sub-queue P, a quantity of to-be-chained local transactions in the sub-queue P reaches the first threshold (for example, the first threshold is 5), and the to-be-processed local transactions are taken from the sub-queue P, that is, the to-be-processed local transactions L1, L3, L5, L7, and L9 are taken and are sent to the global consensus node.

This aspect has the following advantage: To-be-processed local transactions of the same transaction type are stored in the same queue for batch sending, and the global consensus node may uniformly execute these to-be-processed local transactions by using a target smart contract corresponding to the same transaction type (the target smart contract or the target contract is a smart contract for summarizing processing of to-be-processed local transactions of a transaction type, and includes code for summarizing processing of to-be-processed local transactions of a transaction type). This reduces a quantity of times of calling target smart contracts of different transaction types for execution, and improves the execution efficiency. For example, the global consensus node receives a to-be-processed local transaction sent from the sub-queue P, and all to-be-processed local transactions in the sub-queue are executed by using a target smart contract T. In this case, when processing these to-be-processed local transactions, the global consensus node may process all the transactions by using the target smart contract T. This alleviates a problem that the processing efficiency of the global consensus node is reduced because a target smart contract needs to be changed for a plurality of times.

If only that the quantity reaches the first threshold is considered based on the predetermined condition, timeliness of sending is affected. Consequently, some to-be-processed local transactions cannot be summarized for a long time. If only that the time difference reaches the second threshold is considered, although timeliness is ensured, a quantity of transactions sent each time may be excessively small and network resources are wasted. Similarly, if both that the quantity reaches the first threshold and that the time difference reaches the second threshold are considered, the time difference may already reach the second threshold but the quantity still cannot reach the first threshold, and timeliness of sending is still affected.

In an aspect, to balance both timeliness of sending and reduction of network resource occupation, the predetermined condition may be: in response to that a quantity of to-be-processed local transactions in the queue does not reach the first threshold, and in response to that a time difference between a current time and a time at which the to-be-processed local transaction is transmitted to the global consensus network most recently in the queue reaches the second threshold. Referring to FIG. 12, operation 1013 specifically includes:

Operation 1211: Take the to-be-processed local transaction from the queue and send the to-be-processed local transaction to the global consensus network if a quantity of to-be-processed local transactions in the queue reaches a first threshold.

Operation 1212: Determine, if the quantity of to-be-processed local transactions in the queue does not reach the first threshold, a time difference between a current time and a time at which the to-be-processed local transaction is transmitted to the global consensus network most recently.

Operation 1213: Take the to-be-processed local transaction from the queue and send the to-be-processed local transaction to the global consensus network if the time difference reaches a second threshold.

In this aspect, still referring to FIG. 11, assuming that the first threshold is 5, after the to-be-processed local transaction L9 is placed in the sub-queue P, the quantity of the to-be-processed local transactions in the sub-queue P reaches the first threshold, and the to-be-processed local transactions may be taken from the sub-queue P and sent to the global consensus network. However, before the to-be-processed local transaction L9 is placed in the sub-queue P, if the time difference between a current time and a time at which the to-be-processed local transaction is transmitted to the global consensus network most recently reaches the second threshold, although the quantity of to-be-processed local transactions in the sub-queue P does not reach the first threshold, the to-be-processed local transactions can be taken from the queue and sent to the global consensus network. In this way, with reference to the quantity and the time difference, the quantity of transactions sent each time is not excessively small and network resource waste is avoided. In addition, timeliness is considered and this avoids that some to-be-processed local transactions cannot be summarized for a long time.

The first implementation of operation 310 is described in detail above, and a second implementation is described in detail below.

In the second implementation, each to-be-processed local transaction has a different requirement on urgent summarizing processing. For example, the to-be-processed local transaction is an invoice reimbursement transaction, and the invoice reimbursement transaction is a transaction that requires urgent summarizing processing, and needs to be sent to the global consensus network as soon as possible. Apparently, the first implementation cannot implement urgent forwarding of the to-be-processed local transaction. Therefore, in an aspect, the to-be-processed local transaction needs to be forwarded to the global consensus network in time based on a requirement of the to-be-processed local transaction on urgent summarizing processing.

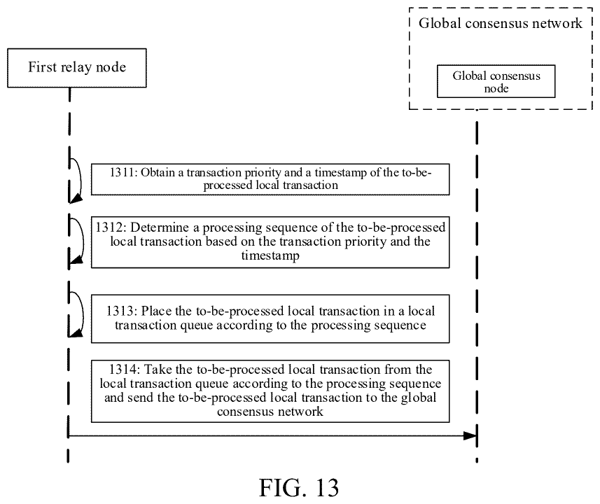

In a specific implementation of this aspect, the global consensus node is located in a global consensus network. Referring to FIG. 13, the to-be-processed local transaction is transmitted to the global consensus network by the first relay node in the following manner:

Operation 1311: Obtain a transaction priority and a timestamp of the to-be-processed local transaction.

Operation 1312: Determine a processing sequence of the to-be-processed local transaction based on the transaction priority and the timestamp.

Operation 1313: Place the to-be-processed local transaction in a local transaction queue according to the processing sequence.

Operation 1314: Take the to-be-processed local transaction from the local transaction queue according to the processing sequence and send the to-be-processed local transaction to the global consensus network.

The following describes operations 1311 to 1314 in detail.

In operation 1311, the transaction priority is used for indicating a processing priority of the to-be-processed local transaction, and the timestamp is used for indicating a generation time of the to-be-processed local transaction. A higher transaction priority indicates that the to-be-processed local transaction has a higher processing priority and the to-be-processed local transaction needs to be preferentially forwarded to the global consensus network. A larger time difference between the timestamp and the current time indicates that the to-be-processed local transaction has not been forwarded, but is a transaction that has been received earlier, and also needs to be preferentially forwarded to the global consensus network.

In some aspects, a manner of obtaining the transaction priority includes, but is not limited to, the following manners:

(1) Determine a transaction type of the to-be-processed local transaction, and search a reference table of the transaction type and the priority according to the transaction type, to determine a transaction priority. The following is an example of a reference table of the transaction type and the priority:

TABLE 2

| Transaction type | Priority |
|---|---|
| Invoice reimbursement type | 10 |
| Invoice query type | 9 |
| Invoice issuance type | 8 |

As shown in Table 2, for the invoice reimbursement type as the transaction type, a to-be-processed local transaction of the invoice reimbursement type is urgently in need of summarizing, and therefore, the priority is set to 10. Similarly, the priority of the invoice query type is set to 9, and the priority of the invoice issuance type is set to 8 according to different urgency degrees of the transaction types in need of summarizing.

For example, content of the to-be-processed local transaction L9 includes “invoice reimbursement A005 of company A with an amount 700 in June”, and a transaction type of this transaction is the invoice reimbursement type. In this case, it is determined, by searching table 2, that the priority is 10.

(2) Obtain a priority identifier from content of the to-be-processed local transaction, and determine a transaction type of the to-be-processed local transaction according to the priority identifier.

For example, content of a to-be-chained local transaction includes “invoice reimbursement A004 of company A with an amount 200 in June; [priority: 10]”. According to the priority identifier “[priority: 10]”, it is determined that the priority is 10.

In some aspects, a manner of obtaining the timestamp includes, but is not limited to, the following manners:

(1) Obtain a timestamp from a to-be-processed local block in which a to-be-processed local transaction is recorded.

(2) Obtain a timestamp identifier from content of the to-be-processed local transaction and determine a timestamp according to the timestamp identifier.

For example, content of a to-be-chained local transaction includes “invoice reimbursement A004 of company A with an amount 200 in June; [timestamp: XX year XX month XX day]”. According to the timestamp identifier “[timestamp: XX year XX month XX day]”, it is determined that the timestamp is XX year XX month XX day.

In operation 1312, a higher transaction priority indicates a higher priority of a processing sequence of the to-be-processed local transaction in a to-be-processed local transaction queue, and a larger time difference between the timestamp and a current time indicates a higher priority of the processing sequence. For example, assuming that the current time is May 7, 2023, the priority of the to-be-processed local transaction L9 is 10, and the timestamp is May 4, 2023, the time difference is 3 days. Then, it is determined that the processing sequence of the to-be-processed local transaction L9 is 1 according to the priority of 10 and the time difference of 3 days.

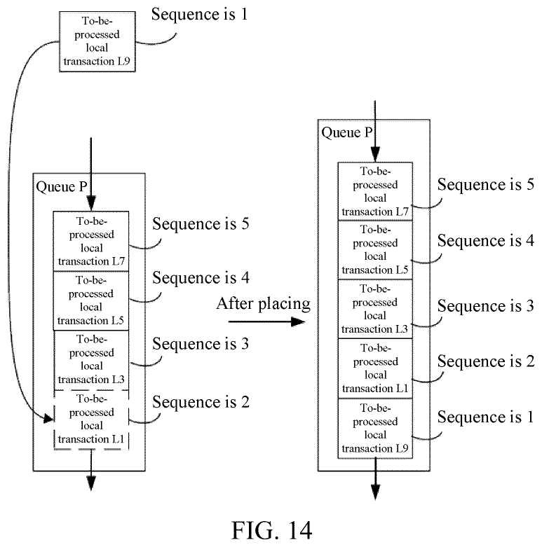

In operation 1313, the to-be-processed local transaction is placed in a to-be-processed local transaction queue according to the processing sequence. The to-be-processed local transaction queue refers to a container for placing a to-be-processed local transaction. For example, referring to FIG. 14, FIG. 14 shows a queue P before the to-be-processed local transaction L9 is placed and a queue P after the to-be-processed local transaction L9 is placed. The to-be-processed local transactions L1, L3, L5, and L7 have been placed in the queue P, and processing sequences are 2, 3, 4, and 5 in sequence. In this case, the processing sequence of the to-be-processed local transaction L9 is 1. According to an ascending order of the processing sequences, it is determined that the to-be-processed local transaction L9 needs to be placed in a target location of the queue P, that is, a dashed-line box of the queue P on the left of FIG. 14. The to-be-processed local transaction L1 in the target location and the to-be-processed local transactions L3, L5, and L7 that rank behind the target location are moved backwards, and then the to-be-processed local transaction L9 is placed in the target location of the queue P. A placement result is the queue P on the right of FIG. 14.

In operation 1314, the to-be-processed local transaction is taken from the to-be-processed local transaction queue according to the processing sequence and the to-be-processed local transaction is sent to the global consensus network.

In an aspect, a manner of taking, which may also be referred to as transferring, the to-be-processed local transaction from the local transaction queue includes:

(1) Take the to-be-processed local transaction from the local transaction queue according to the processing sequence for packaging and send the to-be-processed local transaction to the global consensus network if determining that a quantity of to-be-processed local transactions in the local transaction queue reaches a third threshold.

(2) Take the to-be-processed local transaction from the local transaction queue according to the processing sequence for packaging and send the to-be-processed local transaction to the global consensus network if determining that a time difference between a current time and a previous packaging time reaches a fourth threshold.

Through operations 1311 to 1314, urgent summarizing of the to-be-processed local transaction is implemented according to the priority and the timestamp, transaction summarizing flexibility is improved, and global transaction chaining flexibility is improved.

Overall description of operations 1311 to 1314 is provided above, and detailed description of operation 1312 is provided below.

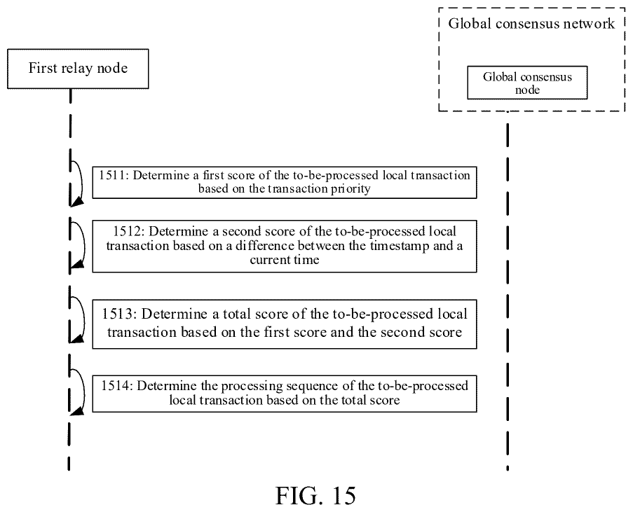

In an aspect, when determining a processing sequence based on a transaction priority and a timestamp of each to-be-processed local transaction, a total score may be calculated according to the transaction priority and the timestamp, and the processing sequence is determined according to the total score. In a specific implementation of this aspect, referring to FIG. 15, operation 1312 includes:

Operation 1511: Determine a first score of the to-be-processed local transaction based on the transaction priority.

Operation 1512: Determine a second score of the to-be-processed local transaction based on a difference between the timestamp and a current time.

Operation 1513: Determine a total score of the to-be-processed local transaction based on the first score and the second score.

Operation 1514: Determine the processing sequence of the to-be-processed local transaction based on the total score.

The following describes operations 1511 to 1514 in detail.

In operation 1511, the first score is determined based on the transaction priority. This can be achieved by searching a reference table of the transaction priority and the first score, or by using a formula.

(1) Search a reference table of the transaction priority and the first score (the reference table of the transaction priority and the first score lists a correspondence between the transaction priority and the first score) according to the transaction priority, to obtain the first score. The following is an example of a reference table of the transaction priority and the first score:

TABLE 3

| Transaction priority | First score |
|---|---|
| Above 10 | 100 |
| 9 | 90 |
| 8 | 80 |
| 7 | 70 |
| 6 | 60 |
| . . . | . . . |

In the above example, the transaction priority of the to-be-processed local transaction L9 is 10. The corresponding first score 100 is obtained by searching Table 3.

The foregoing manner of searching the reference table of the transaction priority and the first score has advantages of simplicity, ease of implementation, and low processing overheads.

(2) When a formula is used, the first score may be set to be directly proportional to the transaction priority, for example,

$$F 1 = K 1 \cdot G . \qquad formula 1$$

F1 represents the first score, G represents the transaction priority, and K1 is a preset constant and may be set based on actual needs. For example, K1=10, and after G=10 is substituted, the first score is F1=100.

The foregoing manner of determining the first score by using a formula has an advantage of high precision, and the formula can be adjusted as required and has high flexibility.

In operation 1512, the second score of the to-be-processed local transaction is determined based on the difference between the timestamp and the current time. This can be achieved by searching a reference table of the difference and the second score, or by using a formula.

(1) First calculate a difference between the timestamp and the current time, and then search a reference table of the difference and the second score (the reference table of the difference and the second score lists a correspondence between the difference and the second score) according to the difference, to obtain the second score. The following is an example of a reference table of the difference and the second score:

TABLE 4

| Difference range | Second score |
|---|---|
| More than 10 days | 100 |

| | | |
|---|---|---|
| 6 to 9 | days | 90 |
| 3 to 5 | days | 80 |
| 2 | days | 70 |
| 0.5 to 1 | day | 60 |

| | |
|---|---|
| . . . | . . . |

In the foregoing example, the difference between the timestamp (May 4, 2023) of the to-be-processed local transaction L9 and the current time (May 7, 2023) is 3 days, and the corresponding second score 80 is obtained by searching table 4.

The foregoing manner of searching the reference table of the difference and the second score has advantages of simplicity, ease of implementation, and low processing overheads.

(2) When a formula is used, the second score may be set to be directly proportional to the difference, for example,

$$F 2 = K 2 \cdot H . \qquad formula 2$$

F2 represents the second score, H represents the difference, and K2 is a preset constant and may be set based on actual needs. For example, K2=80/3, and after H=3 is substituted, the second score is F2=80.

The foregoing manner of determining the second score by using a formula has an advantage of high precision, and the formula can be adjusted as required and has high flexibility.

In operation 1513, based on the first score and the second score, the total score of the to-be-processed local transaction may be determined by calculating an average or a weighted average of the first score and the second score.

When the average of the first score and the second score is calculated as the total score, for example, a first score of the to-be-processed local transaction L9 is 100 and a second score of the transaction is 80, a total score is (100+80)/2=90. Calculating the total score of the to-be-processed local transaction based on an average has the following advantage: The impact of a transaction priority and a difference on a processing sequence of a to-be-processed local transaction in a to-be-processed local transaction queue can be equally reflected.

When the weighted average of the first score and the second score is calculated as the total score, for example, weights of the transaction priority and the difference are respectively set to 0.7 and 0.3, and the first score of the to-be-processed local transaction L9 is 100 and the second score of the transaction is 80, the total score is 100×0.7+80×0.3=94. Calculating the total score based on the weighted average has the following advantage: Different weights may be set for the transaction priority and the difference, and the flexibility of determining a processing sequence of a to-be-processed local transaction in a to-be-processed local transaction queue is improved.

In operation 1514, the processing sequence of the to-be-processed local transaction is determined based on the total score.

In an aspect, a manner of determining the processing sequence includes the following manners:

(1) Search a reference table of the total score and the processing sequence (the reference table of the total score and the processing sequence lists a correspondence between the total score and the processing sequence) according to the total score, to obtain the processing sequence. The following is an example of a reference table of the total score and the processing sequence:

TABLE 5

| Total score range | Processing sequence |
|---|---|
| Above 90 scores | 1 |
| 80 to 89 scores | 2 |
| 70 to 79 scores | 3 |
| 60 to 69 scores | 4 |
| 50 to 59 scores | 5 |
| . . . | . . . |

In the foregoing example, the total score of the to-be-processed local transaction L9 is 90, and it is obtained by searching Table 5 that the corresponding processing sequence is 1.

The foregoing manner of searching the reference table of the total score and the processing sequence has advantages of simplicity, ease of implementation, and low processing overheads.

(2) When a formula is used, the processing sequence may be set to be inversely proportional to the total score, for example,

$$D = K 3 \cdot F 3 + K 4. \qquad formula 3$$

D represents the processing sequence, F3 represents the total score, and K3 and K4 are preset constants and may be set based on actual needs. For example, K3=−2/90 and K4=3, and after F3=90 is substituted, D=1.

The foregoing manner of determining the processing sequence by using a formula has an advantage of high precision, and the formula can be adjusted as required and has high flexibility.

The aspect of determining the processing sequence based on the transaction priority and the difference in operations 1511 to 1514 has the following advantage: A preferential processing requirement of a to-be-processed local transaction is effectively evaluated, and a processing sequence of a to-be-processed local transaction with a relatively high requirement is in the front of a queue, so that the global consensus network preferentially processes the to-be-processed local transaction. This not only alleviates a problem that some to-be-processed local transactions cannot be processed for a long time, but also improves flexibility of processing the to-be-processed local transaction.

The second implementation of operation 310 is described in detail above.

In the first implementation or the second implementation of operation 310, the first relay node forwards the to-be-processed local transaction in the local consensus network and the first verification information to the global consensus network. That is, the global consensus network does not distinguish first relay nodes, and any first relay node may forward a transaction and information to the global consensus network. However, if a first relay node performs malicious forwarding, the global consensus network needs to process a large quantity of useless information, wasting processing resources. Therefore, in an aspect, identity registration is first performed on the first relay node before operation 310, so that in operation 310, with reference to identity authentication, it can be ensured that the to-be-processed local transaction and the first verification information are forwarded by a first relay node that meets a condition.

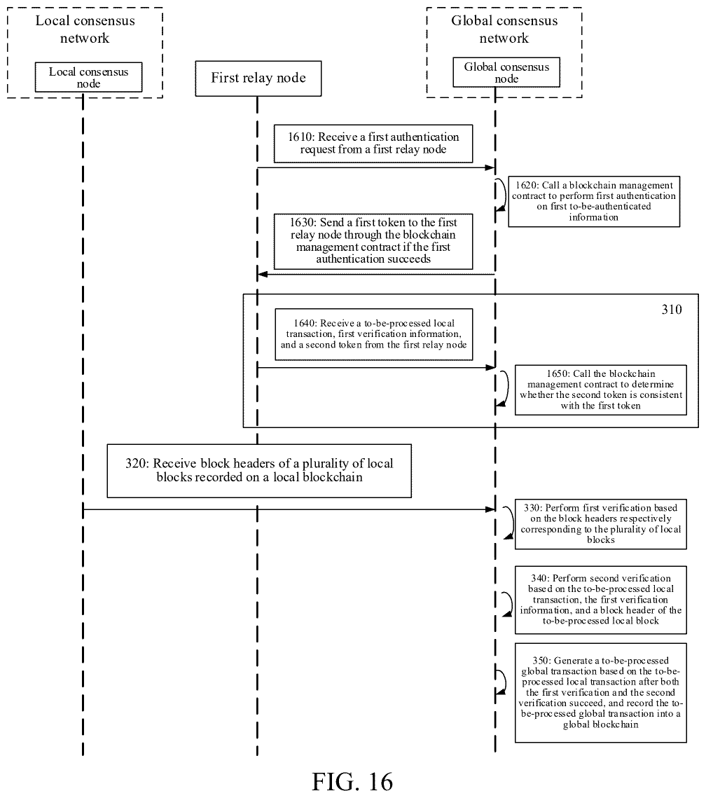

In a specific implementation of this aspect, referring to FIG. 16, before operation 310, the transaction chaining method further includes:

Operation 1610: Receive a first authentication request from a first relay node, where the to-be-processed local transaction is received from the first relay node, and the first authentication request includes first to-be-authenticated information.

Operation 1620: Call a blockchain management contract to perform first authentication on the first to-be-authenticated information.

Operation 1630: Send a first token to the first relay node through the blockchain management contract if the first authentication succeeds.

Correspondingly, operation 310 includes:

Operation 1640: Receive the to-be-processed local transaction, the first verification information, and a second token from the first relay node, where the second token is to be compared with the first token.

In this way, after the second token is received, operation 1650 is further included: Operation 1650: Call the blockchain management contract to determine whether the second token is consistent with the first token.

The following describes operations 1610 to 1650 in detail.

In operation 1610, the first authentication request is a request for identity registration of the first relay node with the global consensus network, and the first to-be-authenticated information in the first authentication request includes identity information of the first relay node. For example, the first authentication information includes a first node identifier of the first relay node and a first key, the first relay node uses the first node identifier and the first key as the first to-be-authenticated information and generates the first authentication request, and sends the first authentication request to the global consensus network.

In operation 1620, after receiving the first authentication request, the global consensus network extracts the first to-be-authenticated information from the first authentication request, and then calls the blockchain management contract to perform first authentication on the first to-be-authenticated information. The blockchain management contract is the smart contract described above. The blockchain management contract is a contract that is established in advance by the global consensus network and that performs the first authentication on the first to-be-authenticated information. The blockchain management contract is responsible for startup registration of all first relay nodes and allocation of the first node identifier. For example, the first authentication information includes the first node identifier of the first relay node and the first key, and the first authentication is performed by calling the blockchain management contract. In this case, the global consensus network stores the first node identifier and the first key in a local database. After storage ends, the first authentication succeeds.

In operation 1630, the first authentication succeeds, and it indicates that the first relay node is registered successfully. The first token is allocated to the first relay node by using the blockchain management contract. The first token belongs to blockchain management contract data, and the blockchain management contract data is a data standard used by the global consensus network to determine identity authentication of the first relay node. For example, after the first relay node receives the first token, the first relay node also needs to send the first token when sending the to-be-processed local transaction and the first verification information to the global consensus network, so that the global consensus network performs identity verification on the first relay node.

In operation 1640, the global consensus node receives the to-be-processed local transaction, the first verification information, and the second token from the first relay node. In operation 1650, the blockchain management contract is called to compare the first token with the second token to determine whether the first token is consistent with the second token. If the first token is consistent with the second token, it indicates that the identity verification succeeds, and the global consensus network performs subsequent processing on the to-be-processed local transaction and the first verification information. However, if the first token is inconsistent with the second token, it indicates that identity verification fails, and the global consensus network filters out the to-be-processed local transaction and the first verification information and no longer performs subsequent processing on the to-be-processed local transaction and the first verification information.

This aspect of performing verification on the first relay node with reference to the blockchain management contract has the following advantage: This alleviates a problem that the global consensus network processes information forwarded by a relay node that does not meet a condition, and improves security and saves processing resources of the global consensus network.

Operation 310 is described above in detail.

### Detailed Description of Operation 320

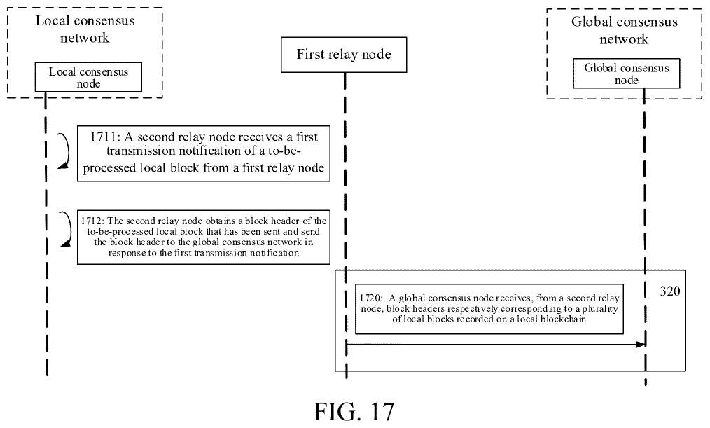

Operation 320: Receive block headers respectively corresponding to a plurality of local blocks recorded on a local blockchain. In an aspect, referring to FIG. 17, operation 320 includes:

Operation 1720: Receive, from a second relay node, the block headers respectively corresponding to the plurality of local blocks recorded on the local blockchain.

In this aspect, still referring to FIG. 17, the block header is sent to the global consensus network by the second relay node in the following manner:

Operation 1711: Receive a first transmission notification of the to-be-processed local block from the first relay node, where the first transmission notification is transmitted after the first relay node transmits the to-be-processed local transaction to the global consensus network.

Operation 1712: Obtain the block header of the to-be-processed local block that has been sent and send the block header to the global consensus network in response to the first transmission notification.

The following describes operations 1711 and 1712 in detail.

In operation 1711, after the first relay node sends the to-be-processed local transaction to the global consensus network, the first relay node generates the first transmission notification, and sends the first transmission notification to the second relay node. The second relay node receives the first transmission notification from the first relay node. It indicates that the first relay node has sent the to-be-processed local transaction to the global consensus network, that is, indicates that the second relay node needs to forward the block header to the global consensus network.

In operation 1712, the second relay node obtains a block header from a to-be-processed local block in response to the first transmission notification, and the block header needs to include the block header of the to-be-processed local block in which the to-be-processed local transaction that has been sent by the first relay node is located.

This aspect has the following advantage: The first relay node sends the to-be-processed local transaction, and the second relay node sends the block header. Therefore, data transmission separation is implemented through separate transmission, thereby reducing tampering risk in a transmission process. In addition, because the block header is also needed during verification of the to-be-processed local transaction, synchronization of the to-be-processed local transaction and the block header is ensured through the first transmission notification, thereby ensuring verification efficiency.

In operation 1720, the second relay node forwards the block header to the global consensus network. That is, the global consensus network does not distinguish second relay nodes, and any second relay node may forward the block header to the global consensus network. However, if a second relay node performs malicious forwarding, the global consensus network needs to process a large quantity of useless block headers, wasting processing resources. Therefore, in an aspect, identity registration is first performed on the second relay node before operation 310, so that in operation 320, with reference to identity authentication, it can be ensured that the block header is forwarded by a second relay node that meets a condition.

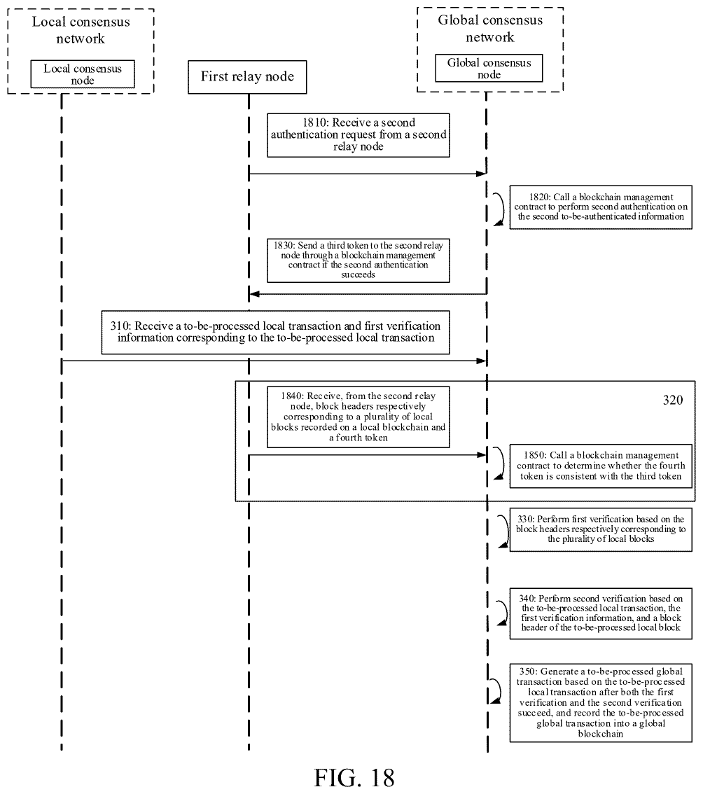

In a specific implementation of this aspect, referring to FIG. 18, before operation 310, the transaction chaining method further includes:

Operation 1810: Receive a second authentication request from a second relay node, where the block headers respectively corresponding the plurality local blocks are received from the second relay node, and the second authentication request includes second to-be-authenticated information.

Operation 1820: Call a blockchain management contract to perform second authentication on the second to-be-authenticated information.

Operation 1830: Send a third token to the second relay node through the blockchain management contract if the second authentication succeeds.

Correspondingly, operation 320 includes:

Operation 1840: Receive, from the second relay node, the block headers respectively corresponding to the plurality of local blocks recorded on the local blockchain and a fourth token, where the fourth token is to be compared with the third token.

In this way, after the fourth token is received, operation 1850 is further included:

Operation 1850: Call the blockchain management contract to determine whether the fourth token is consistent with the third token.

The following describes operations 1810 to 1850 in detail.

In operation 1810, the second authentication request is a request for identity registration of the second relay node with the global consensus network, and the second to-be-authenticated information in the second authentication request includes identity information of the second relay node. For example, the second authentication information includes a second node identifier of the second relay node and a second key, and the second relay node uses the second node identifier and the second key as the second to-be-authenticated information and generates the second authentication request, and sends the second authentication request to the global consensus network.

In operation 1820, after receiving the second authentication request, the global consensus network extracts the second to-be-authenticated information from the second authentication request, and then calls the blockchain management contract to perform second authentication on the second to-be-authenticated information. The blockchain management contract in operation 1820 is similar to the blockchain management contract in operation 1620, and is responsible for startup registration of the second relay node and allocation of the second node identifier. For example, the second authentication information includes the second node identifier of the second relay node and the second key, and the second authentication is performed by calling the blockchain management contract. In this case, the global consensus network stores the second node identifier of the second relay node and the second key in a local database. After storage ends, the second authentication succeeds.

In operation 1830, the second authentication succeeds, and it indicates that the second relay node is registered successfully. The third token is allocated to the second relay node by using the blockchain management contract. The third token belongs to blockchain management contract data, and the blockchain management contract data is a data standard used by the global consensus network to determine identity authentication of the second relay node. For example, after the second relay node receives the third token, the second relay node also needs to send the third token when sending the block header to the global consensus network, so that the global consensus network performs identity verification on the second relay node.

In operation 1840, the global consensus network receives the block header and the fourth token from the second relay node. In operation 1850, the blockchain management contract is called to compare the third token with the fourth token to determine whether the fourth token is consistent with the third token. If the fourth token is consistent with the third token, it indicates that the identity verification on the second relay node succeeds, and the global consensus network performs subsequent processing on the block header. However, if the fourth token is inconsistent with the third token, it indicates that identity verification fails, and the global consensus network filters out the block header and no longer performs subsequent processing on the block header.

This aspect of performing verification on the second relay node with reference to the blockchain management contract has the following advantage: This alleviates a problem that the global consensus network processes a block header forwarded by a second relay node that does not meet a condition, and improves security and saves processing resources of the global consensus network.

Operation 320 is described above in detail.

### Detailed Description of Operation 330

Operation 330: Perform first verification based on the block headers respectively corresponding to the plurality of local blocks.

In an aspect, the block header of the local block includes a first block body digest value of the local block and a second block body digest value of a previous local block of the local block on the local blockchain. Operation 330 includes:
obtaining the first block body digest value from the block header of the to-be-processed local block, and obtaining the second block body digest value from a block header of a next local block of the to-be-processed local block in the plurality of local blocks; and comparing the obtained first block body digest value with the obtained second block body digest value, to complete the first verification; and
determining that the first verification succeeds if the first block body digest value of the to-be-processed local block is the same as a second block body digest value of a next local block of the to-be-processed local block in the plurality of local blocks.

The local blockchain includes a plurality of local blocks. A block header of a genesis block of the plurality of local blocks stores the first block body digest value and has no second block body digest value. Block headers of local blocks in the plurality of local blocks other than the genesis block include the first block body digest value and the second block body digest value. For the same local block, the first block body digest value is a feature value of this local block, and the second block body digest value is a feature value of a previous local block (also referred to as a parent local block) of this local block. For two adjacent local blocks, if a first block body digest value of a previous local block is the same as a second block body digest value of a next local block, it indicates that the two local blocks are truly associated with each other. If the first block body digest value is different from the second block body digest value, it indicates that a local block may have been tampered with, and the two local blocks are not associated with each other.

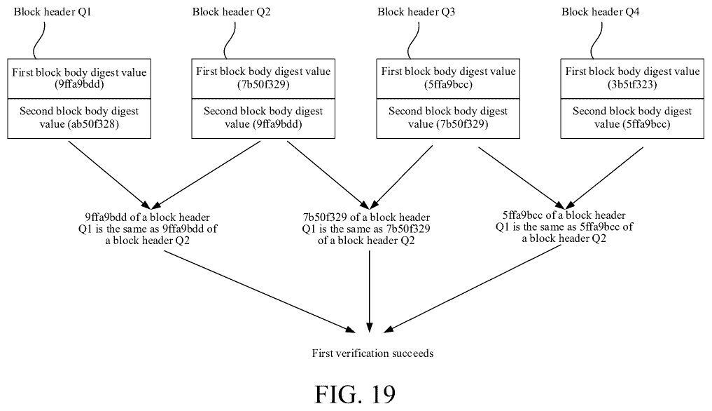

For example, referring to FIG. 19, FIG. 19 is a schematic diagram of an implementation process of performing first verification based on block headers of local blocks. FIG. 19 shows four block headers, including a block header Q1, a block header Q2, a block header Q3, and a block header Q4. A first block body digest value of the block header Q1 is 9ffa9bdd, and a second block body digest value of the block header Q1 is ab50f328. A first block body digest value of the block header Q2 is 7b50f329, and a second block body digest value of the block header Q2 is 9ffa9bdd. A first block body digest value of the block header Q3 is 5ffa9bcc, and a second block body digest value of the block header Q3 is 7b50f329. A first block body digest value of the block header Q4 is 3b5tf323, and a second block body digest value of the block header Q4 is 5ffa9bcc.

Still referring to FIG. 19, the first block body digest value (9ffa9bdd) of the block header Q1 is the same as the second block body digest value (9ffa9bdd) of the block header Q2. It indicates that the block header Q1 and the block header Q2 are truly associated with each other. The first block body digest value (7b50f329) of the block header Q2 is the same as the second block body digest value (7b50f329) of the block header Q3. It indicates that the block header Q2 and the block header Q3 are truly associated with each other. The first block body digest value (5ffa9bcc) of the block header Q3 is the same as the second block body digest value (5ffa9bcc) of the block header Q4. It indicates that the block header Q3 and the block header Q4 are truly associated with each other. Finally, because the block header Q1 and the block header Q2 are truly associated with each other, the block header Q2 and the block header Q3 are truly associated with each other, and the block header Q3 and the block header Q4 are truly associated with each other, it indicates that the first verification succeeds.

This aspect has the following advantage: The first verification is performed on the block header on the global consensus network side based on the intrinsic association of adjacent local blocks. Therefore, it can be determined, without additional verification logic, that the plurality of received local blocks are not tampered with, thereby improving security.

Operation 330 is described above in detail.

### Detailed Description of Operation 340

Operation 340: Perform second verification based on the to-be-processed local transaction, the first verification information, and a block header of the to-be-processed local block.

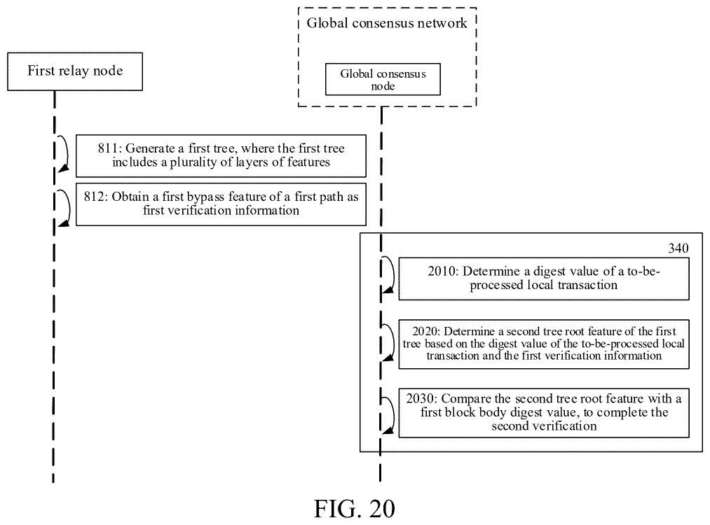

In an aspect, referring to FIG. 20, the first verification information is obtained by the first relay node in the following manner:

Operation 811: Generate a first tree, where the first tree includes a plurality of layers of features.

Operation 812: Obtain a first bypass feature of a first path as first verification information.

Correspondingly, operation 340 includes:

Operation 2010: Determine a digest value of a to-be-processed local transaction.

Operation 2020: Determine a second tree root feature of the first tree based on the digest value of the to-be-processed local transaction and the first verification information.

Operation 2030: Compare the second tree root feature with the first block body digest value, to complete the second verification.

During the second verification, if the second tree root feature is consistent with the first block body digest value, the second verification succeeds. If the second tree root feature is inconsistent with the first block body digest value, the second verification fails.

Operation 811 and operation 812 are already described in detail in the foregoing overall description of operation 310. Operations 2010 to 2030 are described in detail below.

In operation 2010, a digest of the to-be-processed local transaction may be solved by using a digest algorithm, to obtain a digest value of the to-be-processed local transaction. The digest algorithm needs to be used in both operation 2010 and operation 2020, and needs to be the same as a digest algorithm used when the first tree is generated in operation 811, to ensure that the second verification is successfully performed.

Then, in operation 2020, the global consensus node determines the second tree root feature of the first tree based on the digest value of the to-be-processed local transaction and the first verification information.

A process of determining the second tree root feature of the first tree includes: determining a first tree feature corresponding to the digest value of the to-be-processed local transaction, and then reproducing, according to the first bypass feature (the first verification information) and the first tree feature corresponding to the digest value of the to-be-processed local transaction, first tree features (a part circled in a curve in FIG. 9B) on the first path of generating the first tree root feature layer by layer upwards from the first tree feature on the lowest layer corresponding to the to-be-processed local transaction on the first tree, to obtain the second tree root feature.

As shown in FIG. 9B, when determining the second tree root feature of the first tree based on the first bypass feature (the first verification information) and the digest value of the to-be-processed local transaction, it is assumed that the digest value of the to-be-processed local transaction corresponds to a feature of a first tree feature 4, and the extracted first bypass feature includes features of a first tree feature 3, a first tree feature 7, and a first tree feature 12. In this case, a feature of a first tree feature 8 is generated according to a feature of the first tree feature 4 and a bypass feature of the first tree feature 3. A feature of a first tree feature 11 is generated according to the feature of the first tree feature 8 and a bypass feature of the first tree feature 7. A feature of a first tree feature 13 is generated according to the feature of the first tree feature 11 and a bypass feature of the first tree feature 12. This reproduces the first tree features 8, 11, and 13 on the first path of generating layer by layer upwards from the first tree feature 4 on the lowest layer corresponding to the digest value of the to-be-processed local transaction to the first tree feature 13 on the first tree. The feature of the reproduced first tree feature 13 on the first path is used as the second tree root feature.

After obtaining the second tree root feature in operation 2020, the global consensus node compares the second tree root feature with the first block body digest value (the first tree root feature). In operation 2030, if the second tree root feature is consistent with the first block body digest value, the second verification succeeds.

Through operations 2010 to 2030, this aspect of this disclosure ensures that the global consensus node can accurately verify the to-be-processed local transaction, thereby verifying that the transaction is truly recorded and there is no cheating. In addition, leakage of related real information of the transaction is reduced, thereby improving security.

Operation 340 is described above in detail.

### Detailed Description of Operation 350

Operation 350: Generate a to-be-processed global transaction based on the to-be-processed local transaction after both the first verification and the second verification succeed, and record the to-be-processed global transaction into a global blockchain.

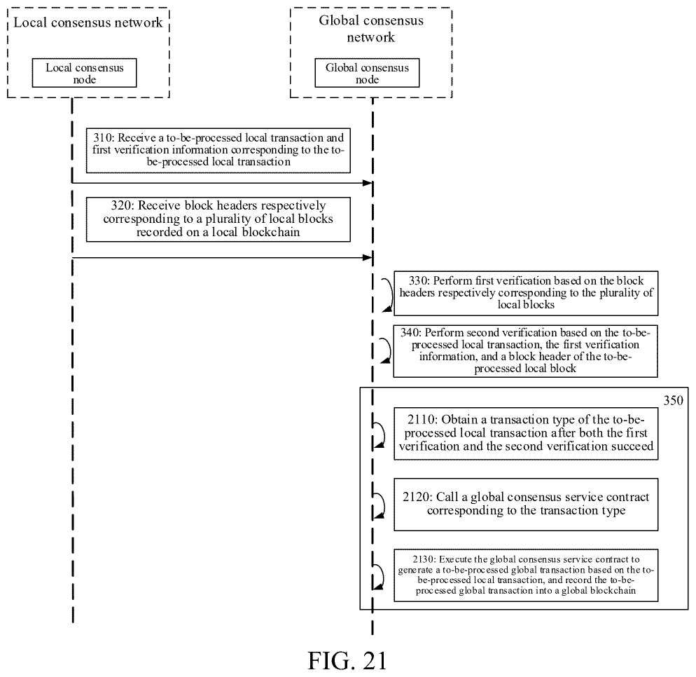

In an aspect, referring to FIG. 21, operation 350 includes:

Operation 2110: Obtain a transaction type of the to-be-processed local transaction after both the first verification and the second verification succeed.

Operation 2120: Call a global consensus service contract corresponding to the transaction type.

Operation 2130: Execute the global consensus service contract to generate the to-be-processed global transaction based on the to-be-processed local transaction, and record the to-be-processed global transaction into the global blockchain.

The following describes operations 2110 to 2130 in detail.

In operation 2110, for a manner of obtaining the transaction type, refer to the manner of determining the transaction type in operation 1011. For brevity, details are not described herein again.

In operation 2120, the global consensus service contract is a contract that summarizes to-be-processed local transactions of a specific transaction type to obtain a global transaction, and chains the global transaction. For example, the global consensus service contract corresponding to a to-be-processed local transaction of an invoice reimbursement type is configured to summarize to-be-processed local transactions of the invoice reimbursement type. The global consensus service contract needs to be executed by all global consensus nodes.

The global consensus service contract may be determined in the following manner: searching a reference table of a transaction type and a global consensus service contract according to a transaction type, to determine a global consensus service contract.

The transaction type may be the invoice reimbursement type, the invoice query type, the invoice issuance type, or the like. The reference table of a transaction type and a global consensus service contract is formulated in advance according to a contract requirement of each transaction type. An example is as follows:

TABLE 6

| Transaction type | Global consensus service contract |
|---|---|
| Invoice reimbursement type | Reimbursement summarizing contract |
| Invoice query type | Query summarizing contract |
| Invoice issuance type | Invoice issuance summarizing contract |

As shown in Table 6, for the invoice reimbursement type as the transaction type, a uniform reimbursement summarizing contract may be set. For the invoice query type as the transaction type, a uniform query summarizing contract may be set. Similarly, for the invoice issuance type, a uniform invoice issuance summarizing contract is set.

After the reference table is formulated, the reference table may be searched according to a transaction type, to determine a global consensus service contract corresponding to the transaction type.

The global consensus network receives a large quantity of to-be-processed local transactions, and each to-be-processed local transaction may require the global consensus node to call a different global consensus service contract. If the global consensus node calls a corresponding contract for each to-be-processed local transaction, processing efficiency is relatively low. In this aspect, the first verification and the second verification are equivalent to that the global consensus node runs a local consensus event verification contract. A processing relationship with a target global consensus service contract may be bound in the local consensus event verification contract, thereby improving processing efficiency. For example, it may be configured that when a to-be-processed local transaction whose transaction type is “invoice reimbursement” is received, after verification, a local consensus event verification contract is the “reimbursement summarizing contract”; and when a to-be-processed local transaction whose transaction type is “invoice issuance” is received, after verification, a local consensus event verification contract is the “invoice issuance summarizing contract”.

In operation 2130, the global consensus service contract is executed to generate the to-be-processed global transaction based on the to-be-processed local transaction, and the to-be-processed global transaction is recorded into the global blockchain.

For example, the three to-be-processed local transactions are respectively “invoice reimbursement A001 of company A with an amount 100 in May”, “invoice reimbursement A002 of company A with an amount 300 in May”, and “invoice reimbursement A003 of company A with an amount 100 in May”. After the first verification and the second verification succeed, the global consensus node obtains that the transaction types of the to-be-processed local transactions are all the invoice reimbursement type, and calls a reimbursement contract of the invoice type. The global consensus node runs the reimbursement contract to generate a to-be-processed global transaction “invoice reimbursement of company A with a total amount 500 in May” based on the three to-be-processed local transactions, and records the to-be-processed global transaction “invoice reimbursement of company A with a total amount 500 in May” into the blockchain. A specific process of recording the to-be-processed global transaction into the global blockchain is similar to the foregoing specific process of recording the local transaction into the local blockchain. Details are not described herein again.

This aspect has the following advantage: A global consensus service contract is called based on a transaction type, to call the global consensus contract to perform batch processing on different to-be-processed local transactions of the same transaction type, thereby improving processing efficiency and improving chaining flexibility of a to-be-processed global transaction.

In this aspect, the global consensus network has one global blockchain, and the global blockchain records all to-be-processed global transactions. However, in another aspect, the local blockchain is a plurality of local blockchains, and the global blockchain is a plurality of global blockchains corresponding to the plurality of local blockchains. In this case, a corresponding global blockchain needs to be selected when recording the to-be-processed global transaction.

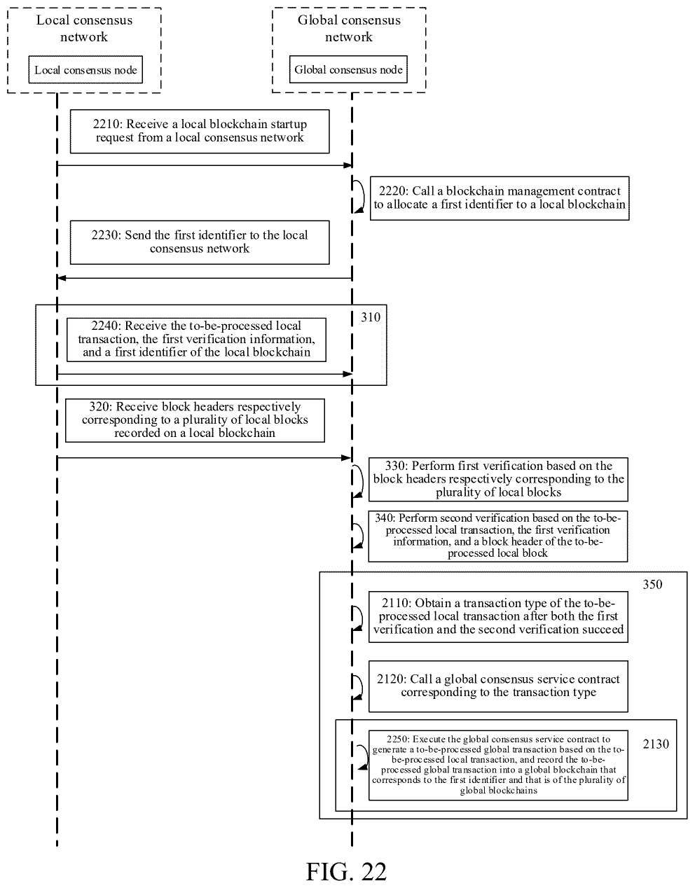

In a specific implementation of this aspect, referring to FIG. 22, before operation 310, the transaction chaining method further includes:

Operation 2210: Receive a local blockchain startup request from a local consensus network.

Operation 2220: Call a blockchain management contract to allocate a first identifier to the local blockchain in response to the local blockchain startup request.

Operation 2230: Send the first identifier to the local consensus network.

Correspondingly, operation 310 includes: Operation 2240: Receive the to-be-processed local transaction, the first verification information, and the first identifier of the local blockchain.

Operation 2130 includes: Operation 2250: Record the to-be-processed global transaction into a global blockchain that corresponds to the first identifier and that is of the plurality of global blockchains.

The following describes operations 2210 to 2250 in detail.

In operation 2210, the local blockchain startup request is a request from the local consensus network to perform identity registration on a blockchain with the global consensus network. The local consensus network actively sends the local blockchain startup request to the global consensus network. Then, in operation 2220, the blockchain management contract is responsible for startup registration of all local blockchains, and the blockchain management contract is called to allocate the first identifier to the local blockchain. Then, in operation 2230, the first identifier is sent to the local consensus network. After receiving the first identifier, when subsequently sending the to-be-processed local transaction to the global consensus network, the local consensus network also needs to send the first identifier, so that the global consensus network determines the corresponding global blockchain according to the first identifier. Then, in operation 310, in addition to the to-be-processed local transaction and the first verification information, the global consensus network further receives the first identifier. After the first identifier is received, in operation 2250, the to-be-processed global transaction needs to be recorded into the global blockchain corresponding to the first identifier.

This aspect has the following advantage: Although the global consensus network summarizes the to-be-processed local transactions, to-be-processed global transactions generated based on local transactions from different local blockchains are not recorded into the same global blockchain. Otherwise, data isolation security is affected. However, in this aspect, the first identifier is allocated to the local blockchain, and the corresponding global blockchain is selected during chaining according to the first identifier. In this way, not only the to-be-processed global transaction can be chained, but also data isolation between to-be-processed global transactions can be implemented, thereby further improving chaining security.

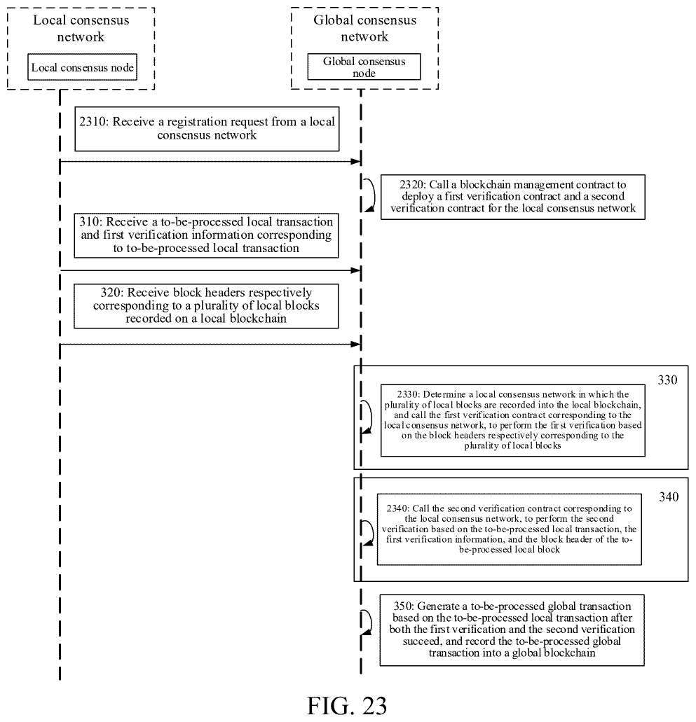

In an aspect, referring to FIG. 23, before operation 310, the transaction chaining method further includes:

Operation 2310: Receive a registration request from a local consensus network.

Operation 2320: Call a blockchain management contract to deploy a first verification contract and a second verification contract for the local consensus network.

Correspondingly, operation 330 includes: Operation 2330: Determine the local consensus network in which the plurality of local blocks are recorded into the local blockchain; and call the first verification contract corresponding to the local consensus network, to perform the first verification based on the block headers respectively corresponding to the plurality of local blocks.

Correspondingly, operation 340 includes: Operation 2340: Call the second verification contract corresponding to the local consensus network, to perform the second verification based on the to-be-processed local transaction, the first verification information, and the block header of the to-be-processed local block.

The following describes operations 2310 to 2340 in detail.

In operation 2310, the registration request is a request from the local consensus network to perform identity registration with the global consensus network. The registration request is generated by the local consensus network and is sent by the local consensus network to the global consensus network.

In operation 2320, in response to the received registration request, the global consensus network calls the blockchain management contract to deploy the first verification contract and the second verification contract for the local consensus network. The blockchain management contract is responsible for startup registration and ID allocation of all local consensus networks, and registration of the first relay node and the second relay node. Data of the blockchain management contract is a data standard for participants to determine local consensus and for identity verification of each relay node. The first verification contract is a contract that verifies a block header. The second verification contract is a contract that verifies a transaction.

In operation 2330, when the local consensus network is registered in the “blockchain management contract”, the “blockchain management contract” deploys a first verification contract for the local consensus network. Block header information submitted by the second relay node is received, checked, and stored in the first verification contract. For example, a height of a current block is 100, and the second relay node submits five block headers having heights of 101 to 105. In this case, the first verification contract performs verification on integrity of the block header 101. The verification is mainly detecting a status of matching between a parent block header digest value in the block header 101 and a digest value of a block header 100 in the first verification contract, consensus information in the block header 101, and the like. After the first verification succeeds, the block header 101 is stored, and verification is successively performed on the block headers 102 to 105. After the block header verification is completed, the first verification succeeds. Data of the first verification contract is provided to the “second verification contract” to verify transaction data.

In operation 2340, the global consensus network receives the to-be-processed local transaction and the corresponding first verification information submitted by the first relay node from the corresponding local consensus network. For example, it is assumed that the second verification contract receives a to-be-processed local transaction submitted from the block height 101. During verification of the second verification contract, a digest value of the to-be-processed local transaction is first calculated according to the to-be-processed local transaction, a first tree root feature is calculated according to a first bypass feature of a first path submitted by the first relay node, the first tree root feature is compared with a second tree root feature in the block header 101 obtained from the “first verification contract”, and if the comparison succeeds, the second verification succeeds.

This aspect has the following advantage: The first verification contract is used to perform security verification on the to-be-processed local block in which the to-be-processed local transaction is located, and the second verification contract is used to perform security verification on the to-be-processed local transaction. In this way, after both the verification succeeds, security of forwarding the transaction across chains and accuracy of chaining the global transaction are ensured.

Implementation Detail Diagram of the Transaction Chaining Method in the Aspects of this Disclosure

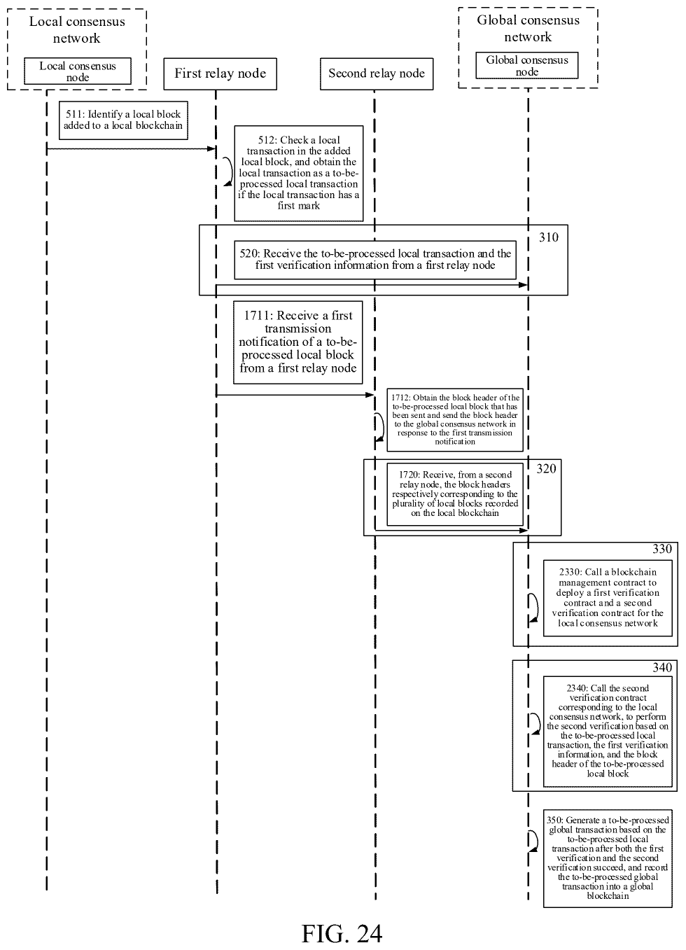

The following describes examples of aspects of implementation details of the transaction chaining method in the aspects of this disclosure with reference to FIG. 24.

Operation 511: A first relay node identifies a local block added to a local blockchain.

Operation 512: The first relay node checks a local transaction in the added local block, and obtains the local transaction as a to-be-processed local transaction if the local transaction has a first mark.

Operation 310 includes: Operation 520: The global consensus node receives the to-be-processed local transaction and the first verification information from the first relay node.

Operation 1711: A second relay node receives a first transmission notification of the to-be-processed local block from the first relay node, where the first transmission notification is transmitted after the first relay node transmits the to-be-processed local transaction to the global consensus network.

Operation 1712: The second relay node obtains a block header of the to-be-processed local block that has been transmitted and transmits the block header to the global consensus network in response to the first transmission notification.

Operation 320 includes: Operation 1720: The global consensus node receives, from the second relay node, block headers respectively corresponding to a plurality of local blocks recorded on a local blockchain.

Operation 330 includes: Operation 2330: Determine the local consensus network in which the plurality of local blocks are recorded into the local blockchain; and call the first verification contract corresponding to the local consensus network, to perform the first verification based on the block headers respectively corresponding to the plurality of local blocks.

Operation 340 includes: Operation 2340: Call the second verification contract corresponding to the local consensus network, to perform the second verification based on the to-be-processed local transaction, the first verification information, and the block header of the to-be-processed local block.

Operation 350: Generate a to-be-processed global transaction based on the to-be-processed local transaction after both the first verification and the second verification succeed, and record the to-be-processed global transaction into a global blockchain.

Advantages of this aspect include, but are not limited to: This aspect is based on a multilayer chain framework, and is applicable to large-scale services in a form of blockchain electronic invoice. The form of multilayer chain facilitates hierarchical service governance, and it can be ensured that local blockchains independently run local services. Besides, there is no need to gather traffic of an entire service alliance to a global blockchain. Functions of data isolation, service privacy isolation, and compliance are implemented, and it can be ensured that the global consensus network does not need to carry a large quantity of segmented services, and can focus on key tasks and global governance. Whether a local transaction is used for summarizing is quickly distinguished by determining whether the local transaction belongs to a transaction type specified in a service contract and by adding a first mark. A local blockchain may standardize selection of data messages to be returned to a global blockchain, and it is avoided that a large amount of irrelevant data, account books, transaction information, and the like are returned to the global blockchain, thereby reducing storage costs of the global blockchain and improving processing efficiency. The global blockchain may summarize account book information of the local blockchain by using the second verification contract. Based on this, all data from the local blockchain may be verified without trust. The second relay node sends the block header to implement transmission separation of the transaction and the block header, and the first transmission notification ensures synchronization of the to-be-processed local transaction and the block header, to ensure verification efficiency. Efficiency and accuracy of the first verification and the second verification are improved by deploying the first verification contract and the second verification contract in advance. A standardized, automated, and verifiable protocol for returning a message from a local blockchain to a global blockchain is provided by using an entire protocol framework. After both the first verification and the second verification succeed, insecurity caused by cheating of a third-party relay or network transmission is greatly reduced, and security of forwarding the transaction across chains and accuracy of chaining the global transaction are improved.

Description of an Apparatus and a Device in the Aspects of this Disclosure

Although the operations are displayed sequentially according to the indications of the arrows in the flowcharts, these operations are not necessarily performed sequentially in the sequence indicated by the arrows. Unless otherwise explicitly specified in the aspects, execution of the operations is not strictly limited, and the operations may be performed in other sequences. Moreover, at least some of the operations in the flowcharts may include a plurality of operations or a plurality of stages. The operations or stages are not necessarily performed at the same time but may be performed at different times. Execution of the operations or stages is not necessarily sequentially performed, but may be performed in turn or alternately with other operations or some of other operations or at least some of the stages.

In each specific implementation of this disclosure, when related processing needs to be performed according to data related to a characteristic of a target object, such as attribute information or an attribute information set of the target object, permission or consent of the target object is first obtained. In addition, collection, usage, processing, and the like of the data comply with related laws and regulations and standards. In addition, when attribute information of a target object needs to be obtained in the aspects of this disclosure, individual permission or individual consent of the target object is obtained through a pop-up window or jumping to a confirmation page. After the individual permission or the individual consent of the target object is explicitly obtained, related data of the target object that is necessary for the aspects of this disclosure to operate normally is obtained.

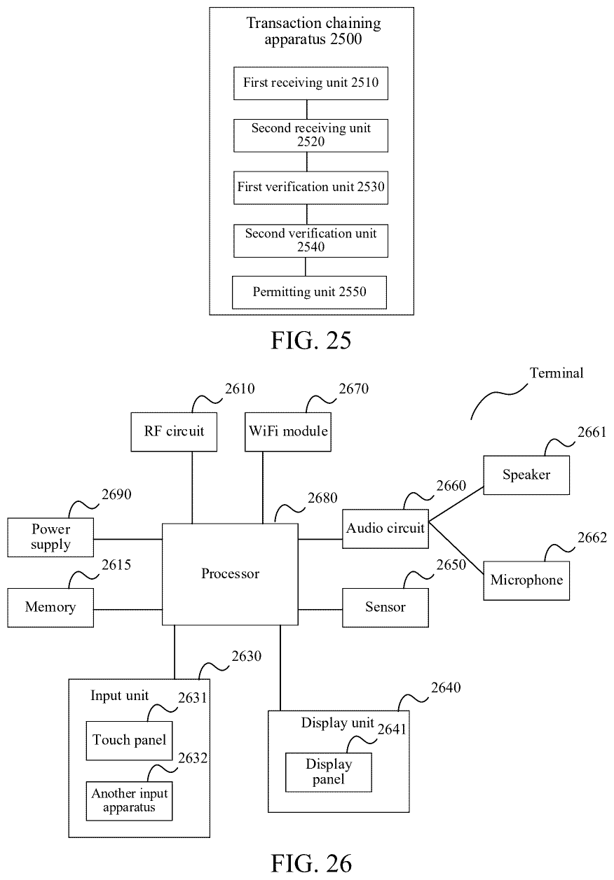

FIG. 25 is a schematic structural diagram of a transaction chaining apparatus 2500 according to an aspect of this disclosure. The transaction chaining apparatus 2500 includes:
a first receiving unit 2510, configured to receive a to-be-processed local transaction and first verification information corresponding to the to-be-processed local transaction, the to-be-processed local transaction being located in a to-be-processed local block, and the to-be-processed local block being recorded on a local blockchain;
a second receiving unit 2520, configured to receive block headers respectively corresponding to a plurality of local blocks recorded on the local blockchain, the plurality of local blocks including the to-be-processed local block;
a first verification unit 2530, configured to perform first verification based on the block headers respectively corresponding to the plurality of local blocks;
a second verification unit 2540, configured to perform second verification based on the to-be-processed local transaction, the first verification information, and a block header of the to-be-processed local block; and
a permitting unit 2550, configured to: generate a to-be-processed global transaction based on the to-be-processed local transaction after both the first verification and the second verification succeed, and record the to-be-processed global transaction into a global blockchain.

In a possible implementation, the block header of the local block includes a first block body digest value of the local block and a second block body digest value of a previous local block of the local block on the local blockchain; and
the first verification unit 2530 is specifically configured to:
obtain the first block body digest value from the block header of the to-be-processed local block, and obtain the second block body digest value from a block header of a next local block of the to-be-processed local block in the plurality of local blocks; and
compare the obtained first block body digest value with the obtained second block body digest value, to complete the first verification.

In a possible implementation, the first receiving unit 2510 is specifically configured to: receive the to-be-processed local transaction and the first verification information from a first relay node; and
the to-be-processed local transaction is obtained by the first relay node in the following manner:
identifying a local block added to the local blockchain; and
checking a local transaction in the added local block, and obtaining the local transaction as the to-be-processed local transaction if the local transaction has a first mark, where the first mark indicates that the local transaction is used to generate the to-be-processed global transaction.

In a possible implementation, a local consensus network recording the local blockchain adds the first mark in the following manner:
obtaining the local transaction;
running a local consensus service contract, and identifying a transaction type specified in the local consensus service contract; and
adding the first mark to the local transaction if the local transaction belongs to the specified transaction type.

In a possible implementation, the first verification information is obtained by the first relay node in the following manner:
generating a first tree, where the first tree includes a plurality of layers of features, the features on the lowest layer of the first tree are digest values of a plurality of local transactions in the to-be-processed local block, the plurality of local transactions include the to-be-processed local transaction, two adjacent features of each layer of the first tree are connected to generate a feature on a higher layer until a first tree root feature of the first tree is generated, and the first tree root feature is a first block body digest value; and
obtaining a first bypass feature of a first path as the first verification information, where the first path is a path from a digest value of the to-be-processed local transaction to the first tree root feature on the first tree, and the first bypass feature is a feature on a next layer to which another feature on the first path other than the digest value of the to-be-processed local transaction is connected; and
the second verification unit 2540 is specifically configured to:
determine the digest value of the to-be-processed local transaction;
determine a second tree root feature of the first tree based on the digest value of the to-be-processed local transaction and the first verification information; and
compare the second tree root feature with the first block body digest value, to complete the second verification.

In a possible implementation, the global consensus node is located in a global consensus network; and the to-be-processed local transaction is transmitted to the global consensus network by the first relay node in the following manner:
determining a transaction type of the to-be-processed local transaction;
placing, based on the transaction type, the to-be-processed local transaction in a queue corresponding to the transaction type; and
taking the to-be-processed local transaction from the queue and transmitting the to-be-processed local transaction to the global consensus network if the queue meets a predetermined condition.

In a possible implementation, the taking the to-be-processed local transaction from the queue and transmitting the to-be-processed local transaction to the global consensus network if the queue meets a predetermined condition includes:
taking the to-be-processed local transaction from the queue and transmitting the to-be-processed local transaction to the global consensus network if a quantity of to-be-processed local transactions in the queue reaches a first threshold; or
determining, if the quantity of to-be-processed local transactions in the queue does not reach the first threshold, a time difference between a current time and a time at which the to-be-processed local transaction is transmitted to the global consensus network most recently; and
taking the to-be-processed local transaction from the queue and transmitting the to-be-processed local transaction to the global consensus network if the time difference reaches a second threshold.

In a possible implementation, the global consensus node is located in a global consensus network; and
the to-be-processed local transaction is transmitted to the global consensus network by the first relay node in the following manner:
obtaining a transaction priority and a timestamp of the to-be-processed local transaction;
determining a processing sequence of the to-be-processed local transaction based on the transaction priority and the timestamp;
placing the to-be-processed local transaction in a local transaction queue according to the processing sequence; and
taking the to-be-processed local transaction from the local transaction queue according to the processing sequence and transmitting the to-be-processed local transaction to the global consensus network.

In a possible implementation, the determining a processing sequence of the to-be-processed local transaction in the to-be-processed local transaction queue based on the transaction priority and the timestamp includes:
determining a first score of the to-be-processed local transaction based on the transaction priority;
determining a second score of the to-be-processed local transaction based on a difference between the timestamp and a current time;
determining a total score of the to-be-processed local transaction based on the first score and the second score; and
determining the processing sequence of the to-be-processed local transaction based on the total score.

In a possible implementation, the second receiving unit 2520 is specifically configured to: receive, from a second relay node, the block headers respectively corresponding to the plurality of local blocks recorded on the local blockchain; and
the block header of the to-be-processed local block is transmitted to the global consensus network by the second relay node in the following manner:
receiving a first transmission notification of the to-be-processed local block from the first relay node, where the first transmission notification is transmitted after the first relay node transmits the to-be-processed local transaction to the global consensus network; and
obtaining the block header of the to-be-processed local block that has been transmitted and transmitting the block header to the global consensus network in response to the first transmission notification.

In a possible implementation, the permitting unit 2550 is specifically configured to:
obtain a transaction type of the to-be-processed local transaction after both the first verification and the second verification succeed;
call a global consensus service contract corresponding to the transaction type; and
execute the global consensus service contract to generate the to-be-processed global transaction based on the to-be-processed local transaction, and record the to-be-processed global transaction into the global blockchain.

In a possible implementation, the local blockchain is a plurality of local blockchains, and the global blockchain is a plurality of global blockchains corresponding to the plurality of local blockchains;
the first receiving unit 2510 is specifically configured to: receive the to-be-processed local transaction, the first verification information, and a first identifier of the local blockchain; and
the permitting unit 2550 is specifically configured to: record the to-be-processed global transaction into a global blockchain that corresponds to the first identifier and that is of the plurality of global blockchains.

In a possible implementation, before receiving the to-be-processed local transaction, the first verification information, and a first identifier of the local blockchain, the transaction chaining apparatus further includes:
a third receiving unit (not shown in the figure), configured to receive a local blockchain startup request from a local consensus network;
an allocation unit (not shown in the figure), configured to call a blockchain management contract to allocate the first identifier to the local blockchain in response to the local blockchain startup request; and
a first sending unit (not shown in the figure), configured to send the first identifier to the local consensus network.

In a possible implementation, before receiving the to-be-processed local transaction and the first verification information corresponding to the to-be-processed local transaction, the transaction chaining apparatus further includes:
a fourth receiving unit (not shown in the figure), configured to receive a first authentication request from a first relay node, where the to-be-processed local transaction is received from the first relay node, and the first authentication request includes first to-be-authenticated information;
a first authentication unit (not shown in the figure), configured to call a blockchain management contract to perform first authentication on the first to-be-authenticated information; and
a second sending unit (not shown in the figure), configured to send a first token to the first relay node through the blockchain management contract if the first authentication succeeds; and
the first receiving unit 2510 is specifically configured to:
receive the to-be-processed local transaction, the first verification information, and a second token from the first relay node, where the second token is to be compared with the first token.

In a possible implementation, before receiving the to-be-processed local transaction and the first verification information corresponding to the to-be-processed local transaction, the transaction chaining apparatus further includes:
a fifth receiving unit (not shown in the figure), configured to receive a second authentication request from a second relay node, where the block headers respectively corresponding to the plurality of local blocks are received from the second relay node, and the second authentication request includes second to-be-authenticated information;
a second authentication unit (not shown in the figure), configured to call a blockchain management contract to perform second authentication on the second to-be-authenticated information; and
a third sending unit (not shown in the figure), configured to send a third token to the second relay node through the blockchain management contract if the second authentication succeeds; and
the second receiving unit 2520 is specifically configured to:
receive, from the second relay node, the block headers respectively corresponding to the plurality of local blocks recorded on the local blockchain and a fourth token, where the fourth token is to be compared with the third token.

In a possible implementation, before receiving the to-be-processed local transaction and the first verification information corresponding to the to-be-processed local transaction, the transaction chaining apparatus further includes:
a sixth receiving unit (not shown in the figure), configured to receive a registration request of the local consensus network; and
a deployment unit (not shown in the figure), configured to call a blockchain management contract to deploy a first verification contract and a second verification contract for the local consensus network; and
the first verification unit 2530 is specifically configured to: determine the local consensus network in which the plurality of local blocks are recorded into the local blockchain; and call the first verification contract corresponding to the local consensus network, to perform the first verification based on the block headers respectively corresponding to the plurality of local blocks; and
the second verification unit 2540 is specifically configured to: call the second verification contract corresponding to the local consensus network, to perform the second verification based on the to-be-processed local transaction, the first verification information, and the block header of the to-be-processed local block.

FIG. 26 is a structural block diagram of a part of a terminal that implements the transaction chaining method in the aspects of this disclosure. The terminal includes: components such as a radio frequency (RF) circuit 2610, a memory 2615, an input unit 2630, a display unit 2640, a sensor 2650, an audio circuit 2660, a Wi-Fi module 2670, a processor 2680, and a power supply 2690. A person skilled in the art may understand that the structure of the terminal shown in FIG. 26 does not constitute a limitation on the terminal, and the terminal may include more components or fewer components than those shown in the figure, or some components may be combined, or a different component deployment may be used.

The RF circuit 2610 may be configured to receive and send signals during an information receiving and sending process or a call process. Particularly, the RF circuit receives downlink information from a base station, then delivers the downlink information to the processor 2680 for processing, and sends related uplink data to the base station.

The memory 2615 may be configured to store a software program and a module, and the processor 2680 executes various function applications and data processing of the terminal of an object by running the software program and the module stored in the memory 2615.

The input unit 2630 may be configured to receive inputted digit or character information, and generate a key signal input related to settings and function control of the terminal of the object. Specifically, the input unit 2630 may include a touch panel 2631 and another input apparatus 2632.

The display unit 2640 may be configured to display inputted information or provided information, and various menus of the terminal of the object. The display unit 2640 may include a display panel 2641.

The audio circuit 2660, a speaker 2661, and a microphone 2662 may provide audio interfaces.

In this aspect, the processor 2680 included in the terminal may perform the transaction chaining method in the foregoing aspects.

The terminal in this aspect of this disclosure includes, but is not limited to, a mobile phone, a computer, a smart voice interaction device, a smart home appliance, an in-vehicle terminal, an aircraft, and the like. This aspect of the present disclosure can be applied to various scenarios, including but not limited to data security, blockchains, data storage, and information technologies.

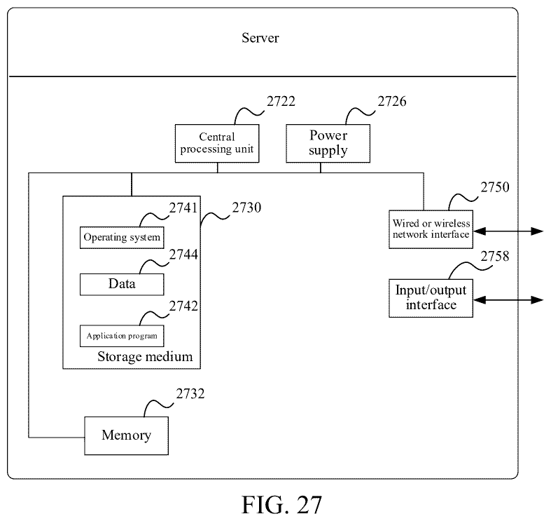

FIG. 27 is a structural block diagram of a part of a server that implements the transaction chaining method in the aspects of this disclosure. The server may vary greatly due to different configurations or performance, and may include one or more central processing units (CPU) 2722 (for example, one or more processors), a memory 2732, and one or more storage mediums 2730 (for example, one or more mass storage apparatuses) that store application programs 2742 or data 2744. The memory 2732 and the storage medium 2730 may be transient or persistent storages. A program stored in the storage medium 2730 may include one or more modules (not marked in the figure), and each module may include a series of instruction operations on the server. Further, the central processing unit 2722 may be configured to communicate with the storage medium 2730, and perform, on the server, the series of instruction operations in the storage medium 2730.

The server may further include one or more power supplies 2726, one or more wired or wireless network interfaces 2750, one or more input/output interfaces 2758, and/or one or more operating systems 2741 such as Windows Server™, Mac OS X™, Unix™, Linux™, and FreeBSD™.

Processing circuitry, such as the central processing unit 2722, in the server may be configured to perform the transaction chaining method in the aspects of this disclosure.

An aspect of this disclosure further provides a computer-readable storage medium, such as a non-transitory computer-readable storage medium, where the computer-readable storage medium is configured to store a computer program, and the computer program is configured to perform the transaction chaining method according to each of the foregoing aspects.

An aspect of this disclosure further provides a computer program product, and the computer program product includes a computer program. A processor of a computer device reads and executes the computer program, to cause the computer device to perform the transaction chaining method.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The terms such as “first”, “second”, “third”, and “fourth” (if exist) in the specification of this disclosure and in the accompanying drawings are used for distinguishing between similar objects and not necessarily used for describing any particular order or sequence. Data used in this way is exchangeable in a proper case, so that the aspects of this disclosure described herein can be implemented in an order different from the order shown or described herein. Moreover, the terms “comprise”, “include”, and any other variants thereof mean to cover the non-exclusive inclusion. For example, a process, a method, a system, a product, or an apparatus that includes a list of operations or units is not necessarily limited to those operations or units that are clearly listed, but may include other operations or units not expressly listed or inherent to such a process, method, product, or apparatus.

In this disclosure, “at least one item (piece)” means one or more, and “a plurality of” means two or more. “And/or” describes an association relationship between associated objects, and represents that there may be three relationships. For example, A and/or B may represent three cases: only A exists, only B exists, and both A and B exist, where A and B may be singular or plural. The character “/” indicates an “or” relationship between the associated objects. “At least one item (piece) of the following” or a similar expression means any combination of these items, including a single item (piece) or any combination of a plurality of items (pieces). For example, at least one item (piece) of a, b, or c may represent: a, b, c, “a and b”, “a and c”, “b and c”, or “a, b, and c”, where a, b, and c can be singular or plural.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In the description of the aspects of this disclosure, a plurality of items (pieces) means more than two, being greater than, being less than, and exceeding a number, and the like are understood as excluding the number, and above, below, and within a number, and the like are understood as including the number.

In the several aspects provided in this disclosure, the disclosed system, apparatus, and method may be implemented in other manners. For example, the described apparatus aspects are merely examples of aspects. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separated, and components displayed as units may or may not be physical units, that is, may be located in one position, or may be distributed on a plurality of network units. Some or all of the units may be selected according to actual needs to achieve the objectives of the solutions of the aspects.

In addition, functional units in the aspects of this disclosure may be integrated into one processing unit, or each of the units may be physically separated, or two or more units may be integrated into one unit. The integrated unit may be implemented in the form of hardware, or may be implemented in a form of a software functional unit.

The integrated unit, if implemented in the form of a software functional unit and sold or used as an independent product, can be stored in a computer-readable storage medium. Based on such an understanding, the technical solutions of this disclosure may be implemented in a form of a software product. The software product is stored in a storage medium, and includes several instructions for instructing a computer apparatus (which may be a personal computer, a server, a network apparatus, or the like) to perform all or some of the operations of methods described in the aspects of this disclosure. The storage medium includes: various mediums capable of storing program code, such as a USB flash drive, a mobile hard disk, a read-only memory (ROM), a random access memory (RAM), a magnetic disk, or an optical disc.

Various implementations provided in the aspects of this disclosure may be combined in different manners to achieve different technical effects.

The foregoing describes examples of the implementations of this disclosure, but this disclosure is not limited to the foregoing implementations. A person skilled in the art may further make various equivalent modifications or replacements without departing from the spirit of this disclosure, and these equivalent modifications or replacements are all included within the scope of this disclosure.

What is claimed is:

1. A transaction chaining method, performed by a global consensus node within a hierarchical blockchain network, comprising:
receiving a to-be-processed local transaction and first verification information corresponding to the to-be-processed local transaction, the to-be-processed local transaction being located in a to-be-processed local block recorded on a local blockchain;
receiving block headers corresponding to a plurality of local blocks recorded on the local blockchain, the plurality of local blocks including the to-be-processed local block;
performing first verification of the block headers corresponding to the plurality of local blocks;
performing second verification based on the to-be-processed local transaction, the first verification information, and a block header of the to-be-processed local block to authenticate the local transaction;
generating a to-be-processed global transaction based on the to-be-processed local transaction and the first verification and the second verification succeeding; and
recording the to-be-processed global transaction into a global blockchain.

2. The transaction chaining method according to claim 1, wherein
the block header of the local block includes a first block body digest value of the local block and a second block body digest value of a previous local block of the local block on the local blockchain; and
the performing the first verification comprises:
obtaining the first block body digest value from the block header of the to-be-processed local block;
obtaining the second block body digest value from a block header of a subsequent local block of the to-be-processed local block in the plurality of local blocks in a transaction sequence; and
comparing the obtained first block body digest value with the obtained second block body digest value in the transaction sequence, to complete the first verification.

3. The transaction chaining method according to claim 1, wherein
the receiving the to-be-processed local transaction and the first verification information includes receiving the to-be-processed local transaction and the first verification information from a first relay node; and
the first relay node is configured to:
identify a local block added to the local blockchain;
check a local transaction in the added local block; and
obtain the local transaction as the to-be-processed local transaction based on the local transaction having a first mark, wherein the first mark indicates that the local transaction is to be included in the to-be-processed global transaction.

4. The transaction chaining method according to claim 3, wherein
the first mark is added to the local transaction by a local consensus network based on the local transaction belonging to a specified transaction type.

5. The transaction chaining method according to claim 3, wherein the performing the first verification information comprises:
generating a first tree, wherein the first tree includes a plurality of layers of features, the features on a lowest layer of the plurality of layers of the first tree includes digest values of a plurality of local transactions in the to-be-processed local block, and the plurality of local transactions includes the to-be-processed local transaction;
generating a feature on a higher layer of the plurality of layers of the first tree until a first tree root feature of the first tree is generated based on two adjacent connected features of each layer of the plurality of layers of the first tree, wherein the first tree root feature is a first block body digest value; and
obtaining the first verification information that includes a first bypass feature of a first path, wherein the first path is from a digest value of the to-be-processed local transaction to the first tree root feature on the first tree, and the first bypass feature is on a next layer to which another feature on the first path other than the digest value of the to-be-processed local transaction is connected.

6. The transaction chaining method according to claim 5, wherein the performing the second verification further comprises:
determining the digest value of the to-be-processed local transaction;
determining a second tree root feature of the first tree based on the digest value of the to-be-processed local transaction and the first verification information; and
comparing the second tree root feature with the first block body digest value to complete the second verification.

7. The transaction chaining method according to claim 3, wherein
the to-be-processed local transaction is transmitted to a global consensus network by the first relay node, wherein the global consensus node is located in the global consensus network.

8. The transaction chaining method according to claim 7, wherein
the to-be-processed local transaction is obtained from a queue and transmitted to the global consensus network based on a quantity of to-be-processed local transactions in the queue of a predefined transaction type reaching a first threshold; and
based on the quantity of the to-be-processed local transactions in the queue not reaching the first threshold,
a time difference between a current time and a time at which the to-be-processed local transaction is transmitted to the global consensus network most recently to the current time is determined; and
the to-be-processed local transaction is obtained from the queue and the to-be-processed local transaction is transmitted to the global consensus network based on the time difference reaching a second threshold.

9. The transaction chaining method according to claim 3, wherein
the to-be-processed local transaction is transmitted to a global consensus network by the first relay node, the global consensus node being located in a global consensus network:
a transaction priority and a timestamp of the to-be-processed local transaction is obtained to determine a processing sequence of the to-be-processed local transaction based on the transaction priority and the timestamp, wherein the determining comprises:
determining a first score of the to-be-processed local transaction based on the transaction priority;
determining a second score of the to-be-processed local transaction based on a difference between the timestamp and a current time;
determining a total score of the to-be-processed local transaction based on the first score and the second score; and
determining the processing sequence of the to-be-processed local transaction based on the total score;
the to-be-processed local transaction in a local transaction queue is placed according to the processing sequence; and
the to-be-processed local transaction is obtained from the local transaction queue according to the processing sequence and the to-be-processed local transaction is transmitted to the global consensus network.

10. The transaction chaining method according to claim 3, wherein
the receiving the block headers includes receiving, from a second relay node, the block headers respectively corresponding to the plurality of local blocks recorded on the local blockchain; and
the second relay node is configured to:
receive a first transmission notification of the to-be-processed local block from the first relay node, wherein the first transmission notification is transmitted after the first relay node transmits the to-be-processed local transaction to the global consensus network;
obtain the block header of the to-be-processed local block that has been transmitted; and
transmit the block header to the global consensus network in response to the first transmission notification.

11. The transaction chaining method according to claim 1, wherein
the generating the to-be-processed global transaction comprises:
obtaining a transaction type of the to-be-processed local transaction after both the first verification and the second verification succeed;
calling a global consensus service contract corresponding to the transaction type; and
executing the global consensus service contract to generate the to-be-processed global transaction based on the to-be-processed local transaction; and
the recording includes recording the to-be-processed global transaction into the global blockchain.

12. The transaction chaining method according to claim 11, wherein
the local blockchain includes a plurality of local blockchains, and the global blockchain includes a plurality of global blockchains corresponding to the plurality of local blockchains;
a local blockchain startup request is received from a local consensus network, a blockchain management contract is called to allocate a first identifier to the local blockchain in response to the local blockchain startup request, and the first identifier is transmitted to the local consensus network,
the receiving the to-be-processed local transaction and the first verification information includes receiving the to-be-processed local transaction, the first verification information, and a first identifier of the local blockchain; and
the recording the to-be-processed global transaction includes recording the to-be-processed global transaction into a global blockchain that corresponds to the first identifier of one of the plurality of global blockchains.

13. The transaction chaining method according to claim 1, further comprising:
receiving a first authentication request from a first relay node, wherein the to-be-processed local transaction is received from the first relay node, and the first authentication request includes first to-be-authenticated information;
calling a blockchain management contract to perform first authentication on the first to-be-authenticated information; and
transmitting a first token to the first relay node through the blockchain management contract based on the first authentication succeeding, wherein
the receiving the to-be-processed local transaction and the first verification information includes receiving the to-be-processed local transaction, the first verification information, and a second token from the first relay node; and
the second token is compared with the first token.

14. The transaction chaining method according to claim 1, further comprising:
receiving a second authentication request from a second relay node, wherein the block headers respectively corresponding to the plurality of local blocks are received from the second relay node, and the second authentication request includes second to-be-authenticated information;
calling a blockchain management contract to perform second authentication on the second to-be-authenticated information; and
transmitting a third token to the second relay node through the blockchain management contract based on the second authentication succeeding, wherein
the receiving the block headers includes receiving, from the second relay node, the block headers respectively corresponding to the plurality of local blocks recorded on the local blockchain and a fourth token, and
the fourth token is compared with the third token.

15. The transaction chaining method according to claim 1, further comprising:
receiving a registration request from a local consensus network; and
calling a blockchain management contract to deploy a first verification contract and a second verification contract associated with the local consensus network, wherein
the performing the first verification comprises:
determining the local consensus network in which the plurality of local blocks are recorded into the local blockchain; and
calling the first verification contract corresponding to the local consensus network, to perform the first verification based on the block headers respectively corresponding to the plurality of local blocks; and
the performing the second verification includes calling the second verification contract corresponding to the local consensus network, to perform the second verification based on the to-be-processed local transaction, the first verification information, and the block header of the to-be-processed local block.

16. A transaction chaining system of a hierarchical blockchain network, comprising:
a global consensus node including processing circuitry, the processing circuitry being configured to:
receive a to-be-processed local transaction and first verification information corresponding to the to-be-processed local transaction, the to-be-processed local transaction being located in a to-be-processed local block recorded on a local blockchain;
receive block headers corresponding to a plurality of local blocks recorded on the local blockchain, the plurality of local blocks including the to-be-processed local block;
perform first verification of the block headers corresponding to the plurality of local blocks;
perform second verification based on the to-be-processed local transaction, the first verification information, and a block header of the to-be-processed local block to authenticate the local transaction;
generate a to-be-processed global transaction based on the to-be-processed local transaction and the first verification and the second verification succeeding; and
record the to-be-processed global transaction into a global blockchain.

17. The transaction chaining system according to claim 16, wherein
the processing circuitry is configured to receive the to-be-processed local transaction and the first verification information from a first relay node; and
the first relay node is configured to:
identify a local block added to the local blockchain;
check a local transaction in the added local block; and
obtain the local transaction as the to-be-processed local transaction based on the local transaction having a first mark, wherein the first mark indicates that the local transaction is to be included in the to-be-processed global transaction.

18. The transaction chaining system according to claim 17, wherein the processing circuitry is configured to:
generate a first tree, wherein the first tree includes a plurality of layers of features, the features on a lowest layer of the plurality of layers of the first tree includes digest values of a plurality of local transactions in the to-be-processed local block, and the plurality of local transactions include the to-be-processed local transaction;
generate a feature on a higher layer of the plurality of layers of the first tree until a first tree root feature of the first tree is generated based on two adjacent connected features of each layer of the plurality of layers of the first tree, wherein the first tree root feature is a first block body digest value; and
obtain the first verification information that includes a first bypass feature of a first path, wherein the first path is from a digest value of the to-be-processed local transaction to the first tree root feature on the first tree, and the first bypass feature is on a next layer to which another feature on the first path other than the digest value of the to-be-processed local transaction is connected.

19. The transaction chaining system according to claim 18, wherein the processing circuitry is configured to:
determine the digest value of the to-be-processed local transaction;
determine a second tree root feature of the first tree based on the digest value of the to-be-processed local transaction and the first verification information; and
compare the second tree root feature with the first block body digest value to complete the second verification.

20. A non-transitory computer-readable storage medium storing instructions which when executed by at least one processor of a global consensus node cause the at least one processor to:
receive a to-be-processed local transaction and first verification information corresponding to the to-be-processed local transaction, the to-be-processed local transaction being located in a to-be-processed local block recorded on a local blockchain;
receive block headers corresponding to a plurality of local blocks recorded on the local blockchain, the plurality of local blocks including the to-be-processed local block;
perform first verification of the block headers corresponding to the plurality of local blocks;
perform second verification based on the to-be-processed local transaction, the first verification information, and a block header of the to-be-processed local block to authenticate the local transaction;
generate a to-be-processed global transaction based on the to-be-processed local transaction and the first verification and the second verification succeeding; and
record the to-be-processed global transaction into a global blockchain.
